(19) United States
(12) Patent Application Publication
(10) Pub. No.: US 2024/0236958 A1
(43) Pub. Date: Jul. 11, 2024

(54) INTER-UE COORDINATION - COORDINATION RESOURCE CONFIGURATION

(71) Applicant: QUALCOMM Incorporated, San Diego, CA (US)

(72) Inventors: Hui GUO, Beijing (CN); Tien Viet NGUYEN, Bridgewater, NJ (US); Shuanshuan WU, San Diego, CA (US); Sourjya DUTTA, San Diego, CA (US); Gabi SARKIS, San Diego, CA (US); Kapil GULATI, Belle Mead, NJ (US)

(21) Appl. No.: 18/561,554

(22) PCT Filed: Jul. 16, 2021
(86) PCT No.: PCT/CN2021/106652

§ 371 Date: Nov. 16, 2023

(51) Int. Cl. H04W 72/0446; H04W 72/25; H04W 72/542

(52) U.S. Cl. CPC H04W 72/0446; H04W 72/25; H04W 72/542

(57) ABSTRACT

Aspects presented herein may enable a UE to transmit or broadcast inter-UE coordination information to one or more UEs based on a set of dedicated-resources or a set of non-dedicated resources. In one aspect, a first UE configures one or more resources in a set of dedicated resources or in a set of non-dedicated resources for a transmission of an inter-UE coordination message, the inter-UE coordination message being associated with at least one of a first stage SCI format or a second stage SCI format. The first UE transmits the inter-UE coordination message via the one or more resources in the set of dedicated resources or in the set of non-dedicated resources.

### TECHNICAL FIELD

The present disclosure relates generally to communication systems, and more particularly, to a wireless communication involving sidelink ranging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus configures one or more resources in a set of dedicated resources or in a set of non-dedicated resources for a transmission of an inter-UE coordination message, the inter-UE coordination message being associated with at least one of a first stage sidelink control information (SCI) format or a second stage SCI format. The apparatus transmits the inter-UE coordination message via the one or more resources in the set of dedicated resources or in the set of non-dedicated resources.

In an aspect of the disclosure, a method, a computer-readable medium, and an apparatus are provided at a second wireless device. The apparatus receives, from a first UE, an inter-UE coordination message via one or more resources in a set of dedicated resources or in a set of non-dedicated resources, the inter-UE coordination message being associated with at least one of a first stage SCI format or a second stage SCI format. The apparatus configures at least one resource in the set of non-dedicated resources based on the received inter-UE coordination message. The apparatus transmits sidelink communication via the at least one resource in the set of non-dedicated resources.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of wireless communication between devices based on sidelink communication in accordance with various aspects of the present disclosure.

FIG. 5 is a diagram illustrating an example resource allocation and reservation in accordance with various aspects of the present disclosure.

FIG. 6 is a diagram illustrating a transmitting device sending coordination information in accordance with various aspects of the present disclosure.

FIG. 7 is a diagram illustrating an example of a UE transmitting inter-UE coordination information based on a dedicated resource in accordance with various aspects of the present disclosure.

FIG. 8 is a diagram illustrating an example of a UE transmitting inter-UE coordination information based on a dedicated resource in accordance with various aspects of the present disclosure.

FIG. 9 is a diagram illustrating an example of a UE transmitting inter-UE coordination information based on a dedicated resource and a resource sensing in accordance with various aspects of the present disclosure

FIGS. 10A and 10B are diagrams showing examples of non-dedicated resources that may be used for transmitting inter-UE coordination messages in accordance with various aspects of the present disclosure.

FIG. 11 is a diagram illustrating an example of a two-stage sidelink control information (SCI) in accordance with various aspects of the present disclosure.

FIG. 12 is a communication flow illustrating an example of transmitting inter-UE coordination information and/or reserving one or more resources for inter-UE coordination information in accordance with various aspects of the present disclosure.

FIG. 13 is a flowchart of a method of wireless communication in accordance with aspects presented herein.

FIG. 14 is a flowchart of a method of wireless communication in accordance with aspects presented herein.

FIG. 15 is a diagram illustrating an example of a hardware implementation for an example apparatus in accordance with aspects presented herein.

FIG. 16 is a flowchart of a method of wireless communication in accordance with aspects presented herein.

FIG. 17 is a flowchart of a method of wireless communication in accordance with aspects presented herein.

FIG. 18 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

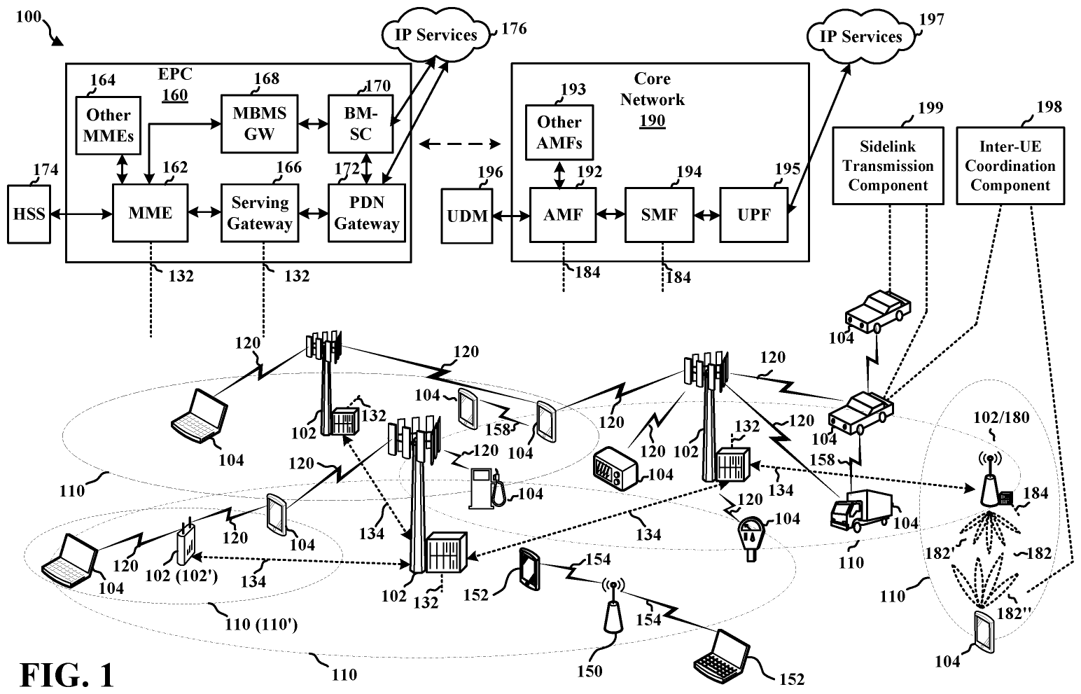

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve the performance and the reliability of sidelink communication, such as sidelink communication that is based on an autonomous sidelink communication. Aspects presented herein may enable one or more sidelink devices to perform an inter-UE coordination in a more effective manner. For example, a first UE may indicate to a second UE one or more suitable and/or non-suitable resources for the second UE's transmission via a coordination message, where the coordination message may be transmitted by the first UE using one or more dedicated resources or non-dedicated resources. In such an example, the one or more dedicated resources or non-dedicated resources for transmitting the inter-UE coordination message may be configured to be periodic resources or aperiodic resource.

In certain aspects, the UE 104 may include an inter-UE coordination component 198 configured to transmit or broadcast inter-UE coordination information to one or more UEs based on a set of dedicated-resources or a set of non-dedicated resources. In one configuration, the inter-UE coordination component 198 may configure one or more resources in a set of dedicated resources or in a set of non-dedicated resources for a transmission of an inter-UE coordination message, the inter-UE coordination message being associated with at least one of a first stage SCI format or a second stage SCI format. In such configuration, the inter-UE coordination component 198 may transmit the inter-UE coordination message via the one or more resources in the set of dedicated resources or in the set of non-dedicated resources.

In certain aspects, the UE 104 may include a sidelink transmission component 199 configured to transmit, reserve and/or schedule sidelink transmissions based at least in part on inter-UE coordination information received from other UE(s). In one configuration, the sidelink transmission component 199 may be configured to receive, from a first UE, an inter-UE coordination message via one or more resources in a set of dedicated resources or in a set of non-dedicated resources, the inter-UE coordination message being associated with at least one of a first stage SCI format or a second stage SCI format. In such configuration, the sidelink transmission component 199 may configure at least one resource in the set of non-dedicated resources based on the received inter-UE coordination message. In such configuration, the sidelink transmission component 199 may transmit sidelink communication via the at least one resource in the set of non-dedicated resources.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, abasic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

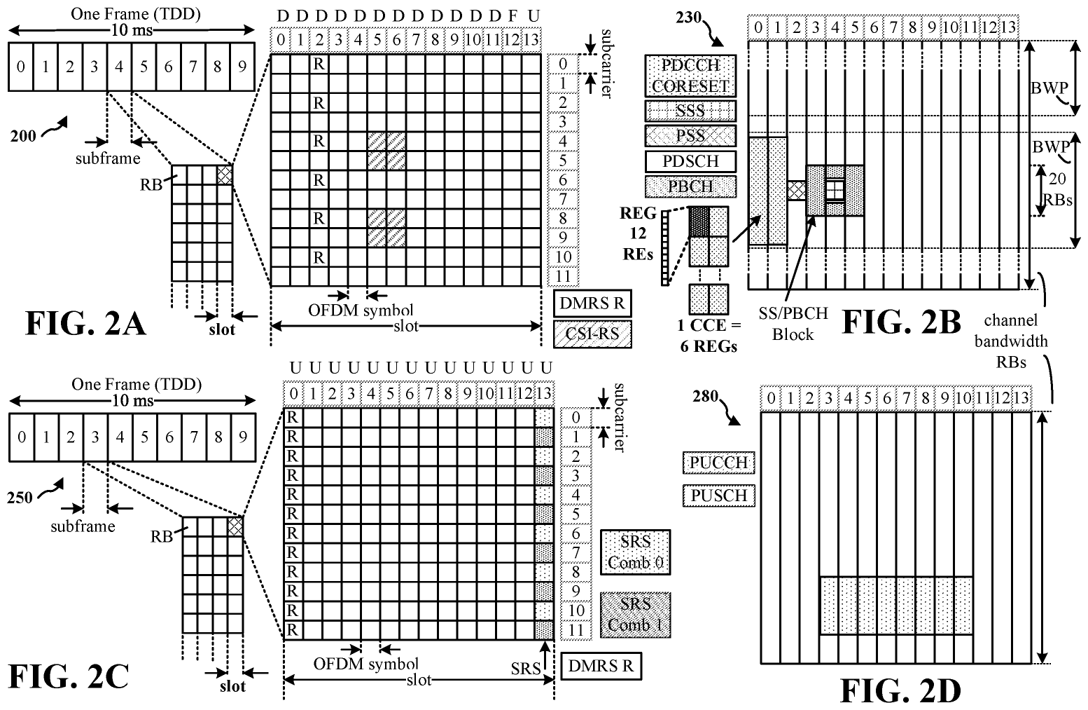

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

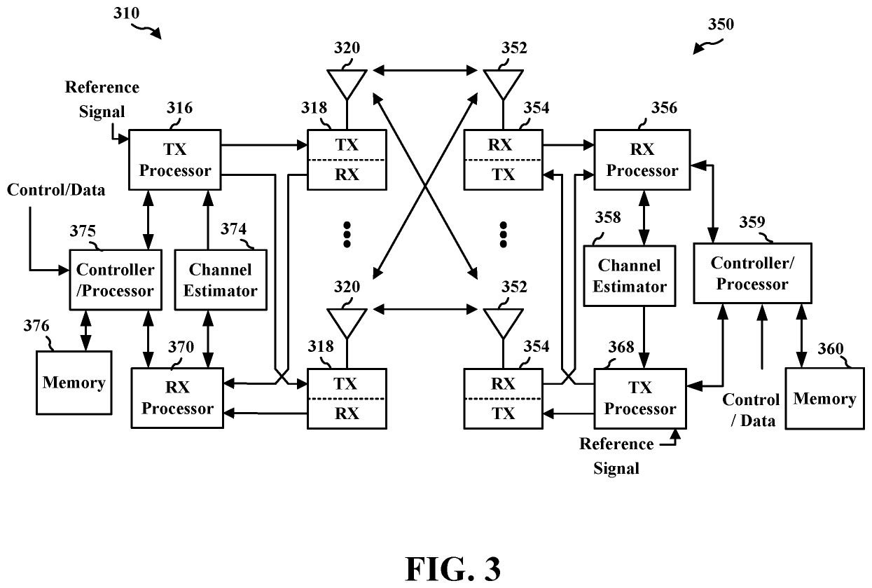

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In one example, at least one of the TX processor 368, the RX processor 356, and the controller/processor 359 may be configured to perform aspects in connection with the inter-UE coordination component 198 of FIG. 1. In another example, at least one of the TX processor 368, the RX processor 356, and the controller/processor 359 may be configured to perform aspects in connection with the sidelink transmission component 199 of FIG. 1. In another example, at least one of the TX processor 368, the RX processor 356, and the controller/processor 359 may be configured to perform aspects in connection with both the inter-UE coordination component 198 and the sidelink transmission component 199 of FIG. 1.

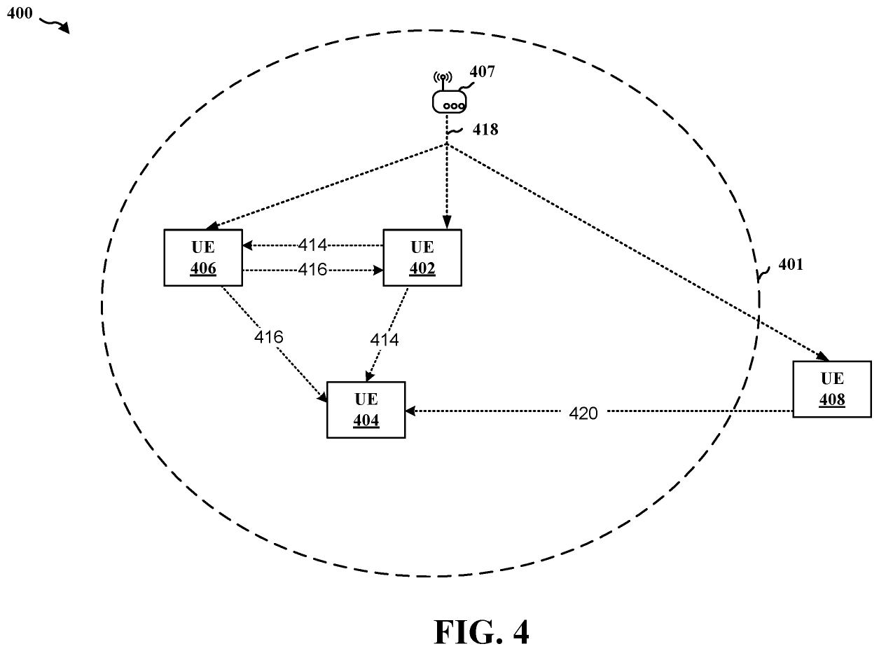

FIG. 4 is a diagram 400 illustrating an example of wireless communication between devices based on sidelink communication. In one example, a UE 402 may transmit a transmission 414, e.g., including a control channel (e.g., a PSCCH) and/or a corresponding data channel (e.g., a PSSCH), that may be received by receiving UEs 404, 406. A control channel may include information for decoding a data channel and may also be used by a receiving device to avoid interference by refraining from transmitting on the occupied resources during a data transmission. The number of transmission time intervals (TTIs), as well as the RBs that will be occupied by the data transmission, may be indicated in a control message (e.g., a sidelink control information (SCI) message) from a transmitting device. The UEs 402, 404, 406, 408 may each have the capability to operate as a transmitting device in addition to operating as a receiving device. Thus, UEs 406, 408 are illustrated as transmitting the transmissions 416 and 420. The transmissions 414, 416, 420 may be broadcast or multicast to nearby devices. For example, the UE 402 may transmit communication (e.g., data) for receipt by other UEs within a range 401 of the UE 402. Additionally, or alternatively, the RSU 407 may receive communication from and/or transmit communication 418 to UEs 402, 406, 408.

Sidelink communication that is exchanged directly between devices may include discovery messages for sidelink UEs to find nearby UEs and/or may include sensing of resource reservations by other UEs in order to select resources for transmission. Sidelink communication may be based on different types or modes of resource allocation mechanisms. In a first resource allocation mode (which may be referred to herein as “Mode 1” or “sidelink Mode 1”), centralized resource allocation may be provided. For example, a base station 102 or 180 may determine resources for sidelink communication and may allocate resources to different UEs 104 to use for sidelink transmissions. In this first mode, a sidelink UE may receive the allocation of sidelink resources from the base station 102 or 180. In a second resource allocation mode (which may be referred to herein as “Mode 2” or “sidelink Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. These resource allocation mechanisms for sidelink may provide power savings, e.g., at a physical layer or a medium access control (MAC) layer. Power savings may be helpful in sidelink applications such as public safety applications, commercial applications, wearables, etc., which may include both periodic and aperiodic traffic.

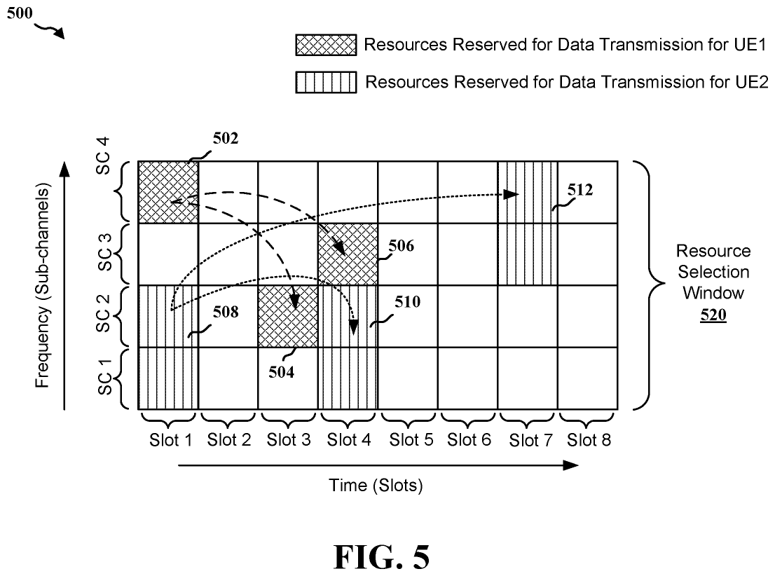

FIG. 5 is a diagram 500 illustrating an example of time-frequency resources reservations for sidelink transmissions. The resource allocation for each UE may be in units of one or more sub-channels in the frequency domain (e.g., sub-channels SC 1 to SC 4), and may be based on one slot in the time domain. A UE may use resources in a current slot to perform an initial transmission, and may reserve resources in future slots for retransmissions. In some examples, a UE (e.g., UE1 and UE2) may reserve up to two different future slots for retransmissions. The resource reservation may be limited to a window of defined slots and sub-channels, and the window may be referred to as a resource selection window. For example, as shown by the diagram 500, a resource selection window 520 may be an eight (8) time slots (e.g., slots #1 to #8) by four (4) sub-channels (e.g., SC #1 to #4) window, which may provide up to thirty-two (32) available resource blocks in total.

Each resource block in the resource selection window 520 may be used by a UE (e.g., a sidelink device) for transmitting data (e.g., physical sidelink shared channel (PSSCH), physical sidelink feedback channel (PSFCH)) and/or control information (e.g., physical sidelink control channel (PSCCH)) if the resource block is available. For example, as shown at 502, a first UE (UE1) may reserve a sub-channel (e.g., SC 4) in a current slot (e.g., slot 1) for its initial data transmission in the resource selection window 520, and the first UE may also reserve additional future slots within the resource selection window 520 for data retransmissions. For example, as shown at 504 and 506, the first UE may reserve sub-channels SC 2 at slot 3 and SC 3 at slot 4 for future retransmissions. The first UE may then transmit information regarding which resources are being used and/or reserved by the first UE to other UE(s), such as by including the reservation information in a reservation resource field of SCI, e.g., first stage SCI. Similarly, as shown at 508, a second UE (UE2) may also reserve resources in sub-channels SC 1 and SC 2 at time slot 1 for its current data transmission. As shown at 510 and 512, the second UE may reserve a first data retransmission at time slot 4 using sub-channels SC 1 and SC 2, and the second UE may reserve a second data retransmission at time slot 7 using sub-channels SC 3 and SC 4. The second UE may then transmit the resource usage and reservation information to other UE(s), such as using the reservation resource field in SCI.

If a third UE (UE3) is configured to transmit a data using resource(s) in the resource selection window 520, the third UE may take resources reserved by other UEs within the resource selection window 520 into a consideration when the third UE is selecting/searching available resources for transmitting the data. For example, the third UE may first receive and decode SCIs (e.g., SCIs transmitted by the first UE, the second UE, and/or other UEs, etc.) within a time period to identify which resources may be available (e.g., candidate resources) in a resource pool (e.g., a resource selection window), and the third UE may exclude resources that have been reserved, such as resources reserved by the first UE and the second UE. Then, the third UE may select one or more resources from available (e.g., non-reserved) candidate resources in the resource pool for its transmission and retransmissions, which may be based on a number of adjacent sub-channels in which the data (e.g., packet) to be transmitted can fit. In one example, the process of a UE detecting which resources are available in a resource selection window or in a sidelink resource pool may be referred to as a “resource sensing” or a “sidelink resource sensing,” which may include decoding SCI(s) received from other UEs and/or determining which resources are available, etc. While FIG. 4 illustrates resources being reserved for an initial transmission and two retransmissions, the reservation may be for more than two retransmissions, for an initial transmission and a single retransmission, or for an initial transmission without retransmission(s), etc.

In some examples, the resource reservation may be periodic or aperiodic. If the resource reservation is periodic, the reservation period may be configured to a value between 0 ms and 1000 ms by signaling in the SCI, and the periodic resource reservation may be disabled by a configuration. Each reservation of resources may have a priority level indicated in the SC. A higher priority reservation may preempt a lower priority reservation. In some examples, smaller priority value may indicate a higher priority compared to a larger priority value. For example, priority value zero (0) may have the highest priority or a priority higher than priority values one (1), two (2), five (5), etc.

In some scenarios, multiple UEs may transmit at the same time and may not receive communications (e.g., SCIs) that are overlapped from each other and/or from a base station. Thus, a UE on a sidelink may miss or may be unaware of transmissions and reservations made by other UEs. For example, referring back to FIG. 5, the first UE and the second UE may transmit at the same time using resources shown at 502 and 508, respectively, and the first UE and the second UE may be unaware of each other's resource reservations as they may not have received SCIs from each other while transmitting. Therefore, the first UE and the second UE may reserve one or more same resource blocks for future transmission(s), which may result in resource collisions. For example, both the first UE and the second UE may reserve the resource shown at 510 for a retransmission, which may result in a resource collision.

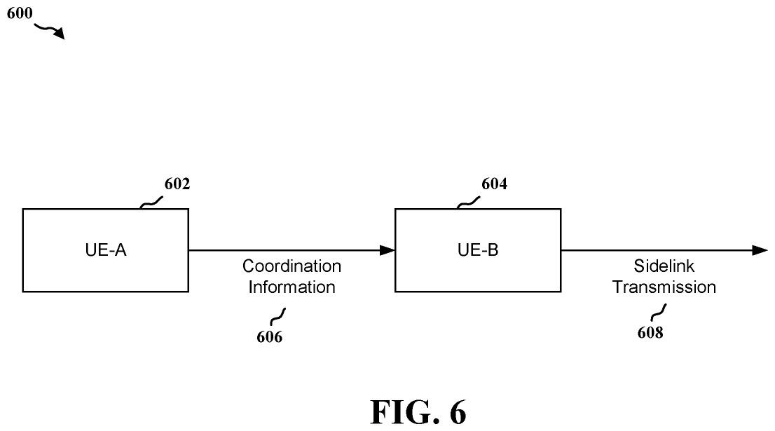

In one example, to reduce or to avoid resource collisions, UEs may coordinate among themselves by generating and sharing their coordination information with other UEs, which may be referred to as an inter-UE coordination. FIG. 6 is a diagram 600 illustrating an example of an inter-UE coordination, where a first UE (“UE-A”) 602 may send coordination information 606 to a second UE (“UE-B”) 604, where the coordination information 606 may include information associated with the first UE 602's own transmission and reservation, the first UE 602's sensing information (e.g., resource reservations of other UEs sensed by the first UE 602), resources that are bad or undesirable around the UE (e.g., (e.g., resources not meeting a defined threshold, resources with high RSRP, resources subject to high interference, etc.), and/or resources which are better than other resources (e.g., resources with less/lower interference among multiple resources), etc. For example, the first UE 602 may use the coordination information 606 to inform or recommend the second UE 604 about which sub-channels and slots may be used by the second UE 604 for communicating with another UE, such as the first UE 602. In other words, the first UE may send coordination information (e.g., Type A coordination information) indicating a suitable/recommended resource(s) for the second UE 604's transmission. Alternatively, or additionally, the first UE 602 may use the coordination information 606 to inform the second UE 604 about which sub-channels and slots may not be used by the second UE 604 as these sub-channels and slots may be occupied or reserved by the first UE 602 and/or other UEs. In other words, the first UE may send coordination information (e.g., Type B coordination information) indicating non-suitable/recommended resource(s) for the second UE 604's transmission. In another example, the first UE 602 may use the coordination information 606 (e.g., Type C coordination information) to inform the second UE 604 about a resource collision or a potential resource collision (e.g., a same resource has been reserved by more than one UE). For purposes of the present disclosure, the coordination information may also be referred to as “inter-UE coordination information,” an “inter-UE coordination message,” and/or a “coordination message,” etc.

In one example, for indicating the suitable/recommended resource(s) to the second UE 604, the first UE 602 may indicate specific resources to be used for the second UE 604's transmission, or the first UE 602 may indicate a set of resources that may be more suitable for the second UE 604's transmission (e.g., those resources may be available based on the first UE 602's evaluation). Alternatively, or additionally, the first UE 602 may indicate a set of resources that may not be suitable for the second UE 604's transmission (e.g., those resources may not be available for the second UE 604 transmission based on the first UE 602's evaluation). In these cases, the first UE 602 may be a receiver or a potential receiver of the second UE 604's transmission. As such, with the inter-UE coordination mechanism, Mode 2 resource allocation may also be based on resource availability from a (potential) receiver's perspective, and the inter-UE coordination mechanism may be used to address hidden node(s) in V2X communication.

Based at least in part on the coordination information 606 received from the first UE 602, the second UE 604 may be able to make a more informed decision on which resources may be used and/or reserved for the second UE 604's sidelink transmission(s) 608 to avoid resource collisions. In some examples, the first UE 602 may share its coordination information 606 with multiple UEs, and the second UE 604 may receive multiple types of coordination information 606 from multiple UEs. In other examples, the first UE 602 may transmit the coordination information 606 using a medium access control (MAC) control element (MAC-CE) on a physical sidelink shared channel (PSSCH).

In some examples, an inter-UE coordination that is performed based on a Mode 2 resource allocation (e.g., the inter-UE coordination information is transmitted based on resource sensing) may support multiple and/or different inter-UE coordination schemes/configurations. For example, in one of inter-UE coordination schemes (e.g., an inter-UE coordination scheme 1), the resource for transmitting the coordination information from a first UE (e.g., UE-A) to a second UE (e.g., UE-B) may be based on a set of suitable resources and/or a set of non-suitable resources for the second UE's transmission. Thus, the first UE may be configured to perform a down-selection between the suitable resource set and the non-suitable resource set, and the first UE may also include additional information other than indicating time/frequency of the resources within the set in the coordination information. In another inter-UE coordination scheme (e.g., an inter-UE coordination scheme 2), the resource for transmitting the coordination information from the first UE to the second UE may be based on a presence of expected/potential and/or detected resource conflict on one or more resources indicated by the second UE's SCI. Thus, the first UE may be configured to perform a down-selection between the expected/potential conflict and the detected resource conflict. In some examples, whether a UE is capable of performing inter-UE coordination (e.g., to transmit the inter-UE coordination message and/or to receive/process the inter-UE process message) and/or which inter-UE coordination scheme to apply may be associated with one or more conditions. In other words, a UE may be specified to meet one or more defined conditions or capabilities in order to transmit the inter-UE coordination message and/or to receive/process the inter-UE process message. For example, UEs (e.g., the first UE) that are capable of or allowed to transmit the inter-UE coordination message may be UEs that are among the intended, targeted or potential receiver(s) of another UE (e.g., the second UE). In another example, a UE may transmit the inter-UE coordination message regardless of whether it is a receiver of another UE. The defined conditions or capabilities in which a UE may transmit the inter-UE coordination message may be configured for the UE via a high-layer configuration, such as by a network or a base station.

Aspects presented herein may improve the performance and the reliability of sidelink communication, such as sidelink communication that is based on an autonomous (Mode 2) sidelink communication. Aspects presented herein may enable one or more sidelink devices to perform an inter-UE coordination in a more effective manner. For example, a first UE may indicate to a second UE one or more suitable and/or non-suitable resources for the second UE's transmission via a coordination message, where the coordination message may be transmitted by the first UE using one or more dedicated resources or non-dedicated resources. In such an example, the one or more dedicated resources or non-dedicated resources for transmitting the inter-UE coordination message may be configured to be periodic resources or aperiodic resource.

In one aspect of the present disclosure, a UE may be configured to transmit inter-UE coordination information (which may also be referred to as an inter-UE coordination message) via one or more resources dedicated for the inter-UE coordination message (hereafter “dedicated resource(s)”). As such, the UE may be able to transmit the inter-UE coordination message instantly without performing a resource sensing. For example, certain sub-channel(s) or frequency band(s) may be dedicated for inter-UE coordination messages, where a sidelink device may use these sub-channel(s) or frequency band(s) to transmit inter-UE coordination messages, but the sidelink device may not use these sub-channel(s) or frequency band(s) to transmit non-inter-UE coordination messages (e.g., control information, feedback, other data, etc.).

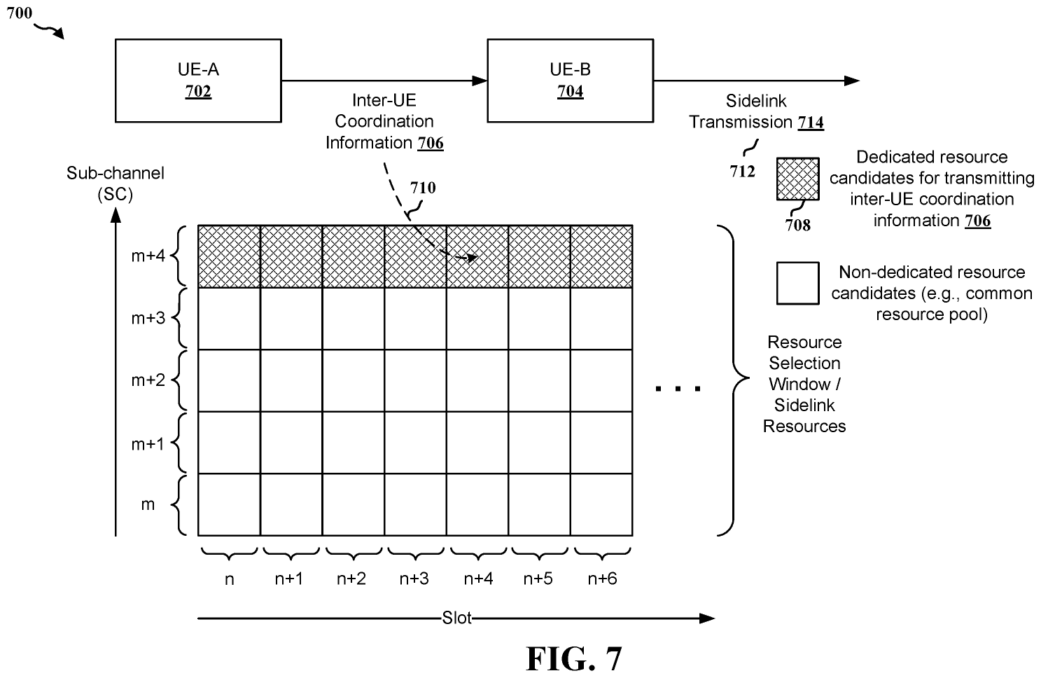

FIG. 7 is a diagram 700 illustrating an example of a UE transmitting inter-UE coordination information based on a dedicated resource in accordance with various aspects of the present disclosure. A first UE 702 may be configured to transmit inter-UE coordination information 706 to a second UE 704 or to broadcast the inter-UE coordination information 706 to other UE(s) using one or more resources that are selected from a dedicated resource pool, e.g., a resource pool with dedicated resources 708 (or “dedicated resource candidates”). The dedicated resources 708 may be reserved by UEs, such as the first UE 702, for transmitting inter-UE coordination information, and the UEs may be configured not to use the dedicated resources for transmitting non-inter-UE coordination information. By providing dedicated resources 708 for the inter-UE coordination information 706, the transmission latency for the inter-UE coordination information 706 may be reduced (e.g., zero (0) slot delay) as the first UE 702 may transmit the inter-UE coordination information 706 to the second UE 704 or broadcast the inter-UE coordination information 706 to UEs within its transmission range using one or more resources selected from the dedicated resources 708 without performing a resource sensing. For example, as shown at 710, if the first UE 702 is configured to transmit or broadcast the inter-UE coordination information 706, the first UE 702 may select a resource (e.g., at slot #n+4 and SC #m+4) from the dedicated resources 708 without performing a resource sensing for the dedicated resources. Such configuration may provide low transmission latency for the inter-UE coordination information 706 as the first UE 702 may forward or transmit the inter-UE coordination information 706 immediately without collision with normal transmissions (e.g., transmissions that are performed based on resource sensing).

A UE that is making a transmission over sidelink may be configured to monitor for inter-UE coordination information from other UE(s) in the dedicated resources 708. For example, as shown at 712, as the second UE 704 may be configured to transmit a sidelink transmission 714 (e.g., to the first UE 702 or to another UE), the second UE 704 may monitor for inter-UE coordination information transmitted from other UE(s) in the dedicated resources 708. If the second UE 704 receives and decodes inter-UE coordination information from the dedicated resources 708, such as the inter-UE coordination information 706 transmitted by the first UE 702, the second UE 704 may transmit the sidelink transmission 714 based on the received/decoded inter-UE coordination information. For example, based on the inter-UE coordination information 706, the second UE 704 may determine which resource(s) may be suitable or recommended for the sidelink transmission 712, which resource(s) may not be suitable or recommended for the sidelink transmission 712, and/or which resource(s) may have resource collision or potential resource collision, etc.

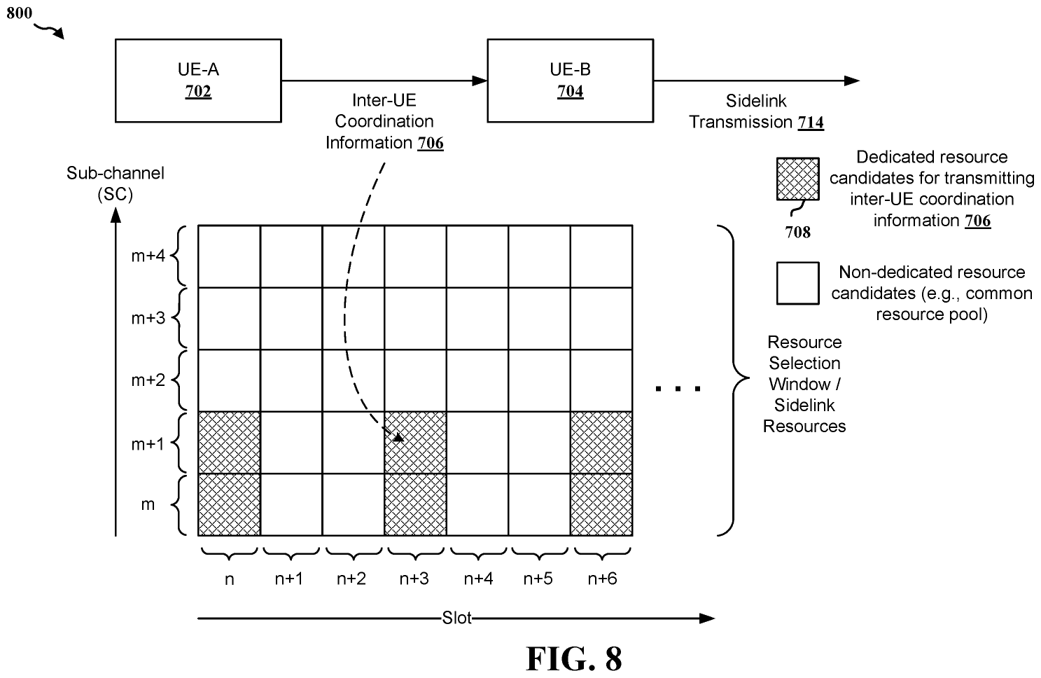

In one example, as shown by the diagram 700, the dedicated resources 708 for inter-UE coordination (e.g., the inter-UE coordination resource) may be allocated at one or more sub-channels (e.g., at SC m+4) of every slot (e.g., at slot n, slot n+1, slot n+2, and so on). Thus, a UE (e.g., the first UE 702) may transmit inter-UE coordination information 706 using the one or more sub-channels of every slot, and a transmitting UE (e.g., the second UE 704) may monitor for inter-UE coordination information in the one or more sub-channels of every slot. In another example, as shown by a diagram 800 of FIG. 8, the dedicated resources 708 for inter-UE coordination (e.g., the inter-UE coordination resource) may be allocated at one or more sub-channels (e.g., at SC m and SC m+1) of every X slots, where X may be an integer greater than or equal to two (X≥2) (e.g., at slot n, slot n+3, slot n+6, and so on). Thus, a UE (e.g., the first UE 702) may transmit inter-UE coordination information 706 using the one or more sub-channels of every X slots, and a transmitting UE (e.g., the second UE 704) may monitor for inter-UE coordination information in the one or more sub-channels of every X slots.

In some scenarios, there may be multiple UEs transmitting inter-UE coordination information based on the dedicated resources 708, which may include the first UE 702. As such, prior to transmitting the inter-UE coordination information 706, the first UE may also decode one or more earlier coordination information (e.g., transmitted/broadcasted by other UEs) to have an up-to-date resource reservation information. While a collision may occur among inter-UE coordination messages if multiple UEs are transmitting the inter-UE coordination messages at a same slot, such collision may have lesser impact to the sidelink communication compared to a collision involving data transmissions (e.g., transmission of higher-priority packets in non-dedicated resources).

In another aspect of the present disclosure, to reduce the likelihood of a collision between inter-UE coordination messages in dedicated resources and/or to provide additional inter-UE coordination resources, UEs that are transmitting or forwarding inter-UE coordination information may be configured to perform resource sensing for the dedicated resources prior to their inter-UE coordination information transmissions. In other words, the inter-UE coordination information transmission may be based on a resource reservation (e.g., a reservation-based transmission), such as described in connection with FIG. 5. Transmitting the inter-UE coordination information with a resource sensing may improve the efficiency of the inter-UE coordination, where collisions between inter-UE coordination messages and/or between an inter-UE coordination message and normal data transmissions may be reduced or avoided.

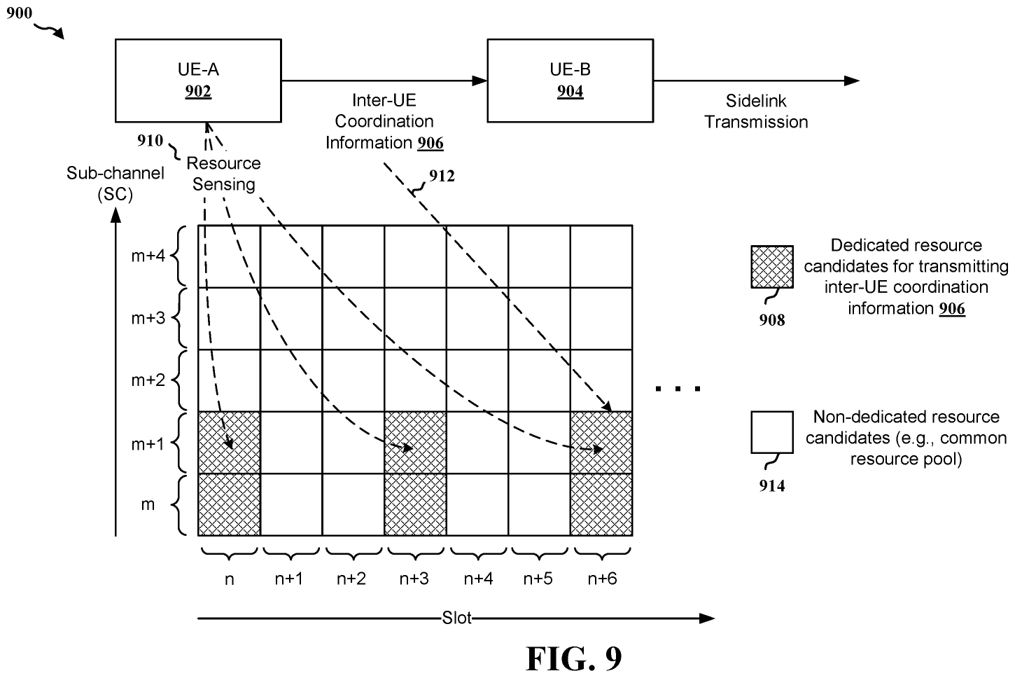

FIG. 9 is a diagram 900 illustrating an example of a UE transmitting inter-UE coordination information based on a dedicated resource and a resource sensing in accordance with various aspects of the present disclosure. A first UE 902 may be configured to transmit inter-UE coordination information 906 to a second UE 904 or to broadcast the inter-UE coordination information 906 to other UE(s) using one or more resources that are selected from a dedicated resource pool, e.g., a resource pool with dedicated resources 908 (or “dedicated resource candidates”). The dedicated resources 908 may be reserved by UEs, such as the first UE 902, for transmitting inter-UE coordination information, and the UEs may be configured not to use the dedicated resources for transmitting non-inter-UE coordination information. In one example, with dedicated resources 908 reserved for inter-UE coordination information, the first UE 902 may be configured to conduct a resource sensing and a resource selection/reservation process as described in connection with FIG. 5 to reserve its inter-UE coordination information transmission resource to avoid or reduce collision with other UEs (e.g., with inter-UE coordination information transmitted by other UEs).

For example, as shown by the diagram 900, the dedicated resources 908 for inter-UE coordination messages (e.g., the inter-UE coordination resource) may be allocated at one or more sub-channels (e.g., at SC m and SC m+1) of every X slots, where X may be an integer greater than or equal to two (X≥2) (e.g., at slot n, slot n+3, slot n+6, and so on). As shown at 910, if the first UE 902 is configured to transmit or broadcast the inter-UE coordination information 906, the first UE 902 may be configured to perform a resource sensing on the dedicated resources 908 to determine whether one or more resources within the dedicated resources 908 have been reserved or used by other UE(s) for transmission (e.g., for transmitting their inter-UE coordination information). Then, as shown at 912, based at least in part on the resource sensing, the first UE 902 may select a resource (e.g., SCs m and m+1 at slot n+6) from the dedicated resources 908 for transmitting the inter-UE coordination information 906 if the first UE 902 determines that this resource is available for transmission (e.g., the resource has not been reserved or occupied by at least one other UE). Such configuration may avoid collisions between inter-UE coordination messages.

In one example, if after the first UE 902 performs the resource sensing and the first UE 902 determines that there are no available resources in the dedicated resources 908 for transmitting the inter-UE coordination information 906, the first UE 902 may be configured to drop the current transmission for the inter-UE coordination information 906. In other words, when there is no resource available within the dedicated resources 908, the first UE 902 may skip the inter-UE coordination information 906 transmission. Then, the first UE 902 may perform another resource sensing for the dedicated resources 908 at a different period (e.g., after slot n+6) to determine whether there is any available resource for transmitting the inter-UE coordination information.

In another example, if after the first UE 902 performs the resource sensing and the first UE 902 determines that there are no available resources in the dedicated resources 908 for transmitting the inter-UE coordination information 906, the first UE 902 may be configured to perform a resource sensing on non-dedicated resources 914 (e.g., a common resource pool or resources that are not dedicated resources 908) to determine whether there are available resources in the non-dedicated resources 914. If there is an available resource in the non-dedicated resources 914, the first UE 902 may transmit the inter-UE coordination information 906 using the available resource. In some examples, the first UE 902 may perform the resource sensing for the dedicated resources 908 and the non-dedicated resources 914 at the same time. For example, as shown by the diagram 900, the first UE 902 may perform the resource sensing for a resource selection window that includes slots n to n+6 and sub-channels m to m+4, where the resource selection window may include both the dedicated resources 908 and the non-dedicated resources 914. Then, the first UE 902 may determine whether there is an available resource in the dedicated resources 908 for transmitting the inter-UE coordination information 906. If the dedicated resources 908 does not have an available resource, the first UE 902 may determine whether there is an available resource in the non-dedicated resources 914 for transmitting the inter-UE coordination information 906.

In another aspect of the present disclosure, to enable a more flexible resource reservation for transmitting inter-UE coordination information, a UE may transmit inter-UE coordination information in a common resource pool (e.g., a resource pool that does not include resources dedicated for inter-UE coordination information) or in non-dedicated resources of a resource pool (e.g., a resource pool that includes both dedicated resources and non-dedicated resources as shown at FIGS. 7 to 9).

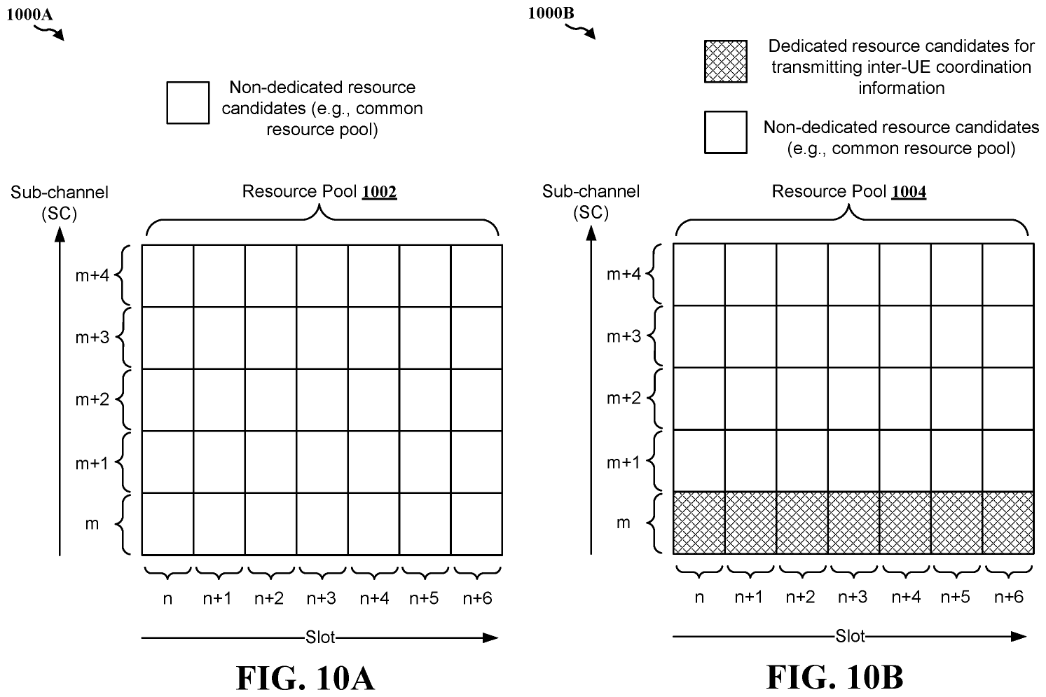

FIGS. 10A and 10B are diagrams 1000A and 1000B showing examples of non-dedicated resources that may be used for transmitting inter-UE coordination messages in accordance with various aspects of the present disclosure. In one example, as shown by the diagram 1000A, if no dedicated resources are configured in a resource pool 1002 for inter-UE coordination message, a UE may perform a resource sensing and a resource reservation process for transmitting the inter-UE coordination message, where the UE may find and reserve an available resource in the resource pool 1002 for transmitting the inter-UE coordination message. The resource sensing and the resource reservation process may be the same as the data transmission described in connection with FIG. 5. In another example, as shown by the diagram 1000B, a resource pool 1004 may include dedicated resources and non-dedicated resources. If there are no dedicated resources available in the resource pool 1004 for transmitting an inter-UE coordination message, a UE may perform a resource sensing and a resource reservation process for transmitting the inter-UE coordination message in the non-dedicated resources, where the UE may find and reserve an available resource in the non-dedicated resources of the resource pool 1002 for transmitting the inter-UE coordination message. Similarly, the resource sensing and the resource reservation process may be the same as or similar to the data transmission described in connection with FIG. 5.

In one example, to avoid or to reduce resource collision with PSCCH, PSSCH, and/or PSFCH transmissions (e.g., if the inter-UE coordination message is transmitted using non-dedicated resource(s)), a UE may be configured to reserve an inter-UE coordination message transmission with a lower transmission priority compared to normal data transmissions (e.g., the PSCCH, PSSCH, and/or PSFCH transmissions). For example, an upper layer of a network may assign or configure a larger priority value (e.g., zero (0) may be the highest priority) for inter-UE coordination transmissions, and the network may assign a lower priority value (e.g., a priority value that is lower than the priority value for the inter-UE coordination transmissions) to PSCCH, PSSCH, and/or PSFCH transmissions. For example, an inter-UE coordination transmission may be assigned with a priority value of five (5) while priority values for PSCCH, PSSCH, and/or PSFCH transmissions may be assigned with priority value(s) below five.

In another example, a UE may be configured to find available resource(s) for transmitting inter-UE coordination information from a common resource pool, non-dedicated resources, or dedicated resources based on an RSRP threshold and an available resource percentage threshold. For example, for resource reservation of a data transmission (e.g., for transmitting PSCCH, PSSCH, and/or PSFCH), a UE may be configured to determine whether a resource in a resource window or a resource pool is available based measuring reference signal received power (RSRP) of the resources in the resource window or the resource pool. If the measured RSRP for a resource is above an RSRP threshold, the UE may determine or consider the resource as being unavailable as the resource may likely be used by another UE. On the other hand, if the measured RSRP for a resource is below the RSRP threshold, the UE may determine or consider the resource as being available.

In another example, if an available resource ratio of the resource window or the resource pool is below an available resource percentage threshold (e.g., X %, 20%, etc.), the UE may further be configured to adjust the value of the RSRP threshold until the available resource percentage threshold is met or until a maximum number of times in which the UE may adjust the value of the RSRP threshold is met. For example, a UE may be configured to determine whether one or more resources in a resource selection window (e.g., a common resource pool) are available based on an RSRP threshold of 10 dB. Thus, if the RSRP measured for a resource within the resource selection window exceeds 10 dB, the UE may consider the resource as being unavailable, whereas if the RSRP measured for a resource within the resource selection window is below 10 dB, the UE may consider the resource as being available.

After performing the RSRP measurement for resources in the resource selection window, the first UE may determine an available resource ratio for the resource selection window, and the first UE may compare the determined available resource ratio with an available resource percentage threshold (e.g., 20%). For example, if a UE senses that 5 resources out of 35 resources in the resource selection window are available for transmission, the available resource ratio for the resource selection window may approximately be 14% (e.g., 5/35). As the available resource ratio (e.g., 14%) is below the available resource percentage threshold (e.g., 20%), the UE may increase the RSRP threshold, such as from 10 dB to 13 dB, and the UE may determine an available resource ratio for the resource selection window again based on the modified RSRP threshold (e.g., 13 dB), and compare the available resource ratio with the modified RSRP threshold. For example, if the UE senses that 14 resources out of 35 resources in the resource selection window are available for transmission based on the modified RSRP threshold (e.g., 13 dB), the available resource ratio for the resource selection window may approximately be 40% (e.g., 14/35). As the available resource ratio (e.g., 40%) is above the available resource percentage threshold (e.g., 20%), the UE may select a resource from the resource selection window for the data transmission. On the other hand, if the available resource ratio for the resource selection window is still below the available resource percentage threshold, the UE may increase the RSRP threshold again (e.g., from 13 dB to 15 dB), and determine another available resource ratio for the resource selection window based on the modified RSRP threshold (e.g., 15 dB).

The UE may be configured to modify the RSRP threshold gradually (e.g., with a fixed dB value at a time) or based on a defined formula (e.g., 2 dB for a first increase, 3 dB for a second increase, etc.) for a maximum number of times (e.g., 2 times, 4 times, etc.). If after modifying the RSRP threshold for the defined maximum number of times and the calculated available resource ratio for the resource selection window is still below the available resource percentage threshold, the UE may not select a resource from the resource selection window for transmission (e.g., the UE may be configured to skip the current transmission). Such RSRP threshold adjustment mechanism may provide the UE with a more flexible resource reservation mechanism as more resources may be available for transmission after the RSRP threshold is increased.

In one aspect of the present disclosure, if a UE is configured to transmit inter-UE coordination information, the UE may also select a resource for transmitting the inter-UE coordination information from a common resource pool (e.g., as shown by FIG. 10A), from non-dedicated resources (e.g., as shown by FIG. 10B if dedicated resources are not available), or from dedicated resources (e.g., as shown by FIGS. 7 to 9) based on an RSRP threshold and an available resource percentage threshold. In one example, for inter-UE coordination information resource reservation, the available resource percentage threshold (e.g., X %) may be configured to be a smaller or lower value (e.g., 2%, 5%, etc.) compared to an available resource percentage threshold configured for data transmissions (e.g., 20%). By configuring a smaller or lower available resource percentage threshold for inter-UE coordination information resource reservation, there may be more or sufficient resources for data transmission (e.g., transmission of PSCCH, PSSCH, and/or PSFCH), and less collision may occur between an inter-UE coordination message and the data transmission.

As such, when the UE is configured to select a resource from the common resource pool, the non-dedicated resources, or the dedicated resources, the UE may first calculate an available resource ratio for the common resource pool, the non-dedicated resources, or the dedicated resources using the RSRP threshold. Then, the UE may determine whether to select a resource from the common resource pool, the non-dedicated resources, or the dedicated resources based on whether the calculated available resource ratio exceeds the available resource percentage threshold. Similarly, the UE may be configured to modify the RSRP threshold for the inter-UE coordination information resource reservation if the calculated available resource ratio for the common resource pool, the non-dedicated resources, or the dedicated resources calculated based on the RSRP threshold is below the available resource percentage threshold, such as described above. For example, the UE may be configured to modify the RSRP threshold (e.g., by Y dB) until the available resource percentage threshold (X %) is met (e.g., until X % of available resources are identified) or until a maximum number of times in which the UE may modify the RSRP threshold is met. In one example, the available resource percentage threshold (X %) and/or the maximum number of times in which the UE may modify the RSRP threshold (e.g., the maximum RSRP threshold increasing times) for the inter-UE coordination information resource reservation may be (pre)configured by a network or based on the UE's implementation (e.g., pre-configuration).

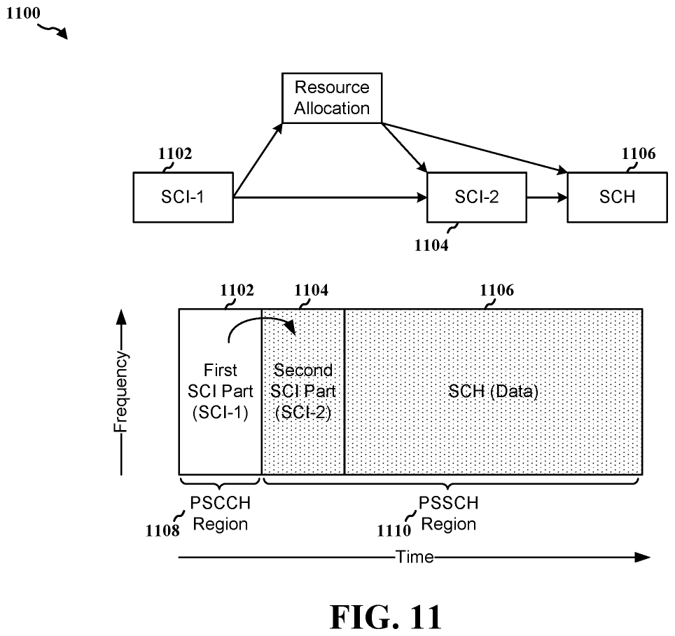

A sidelink resource reservation may be periodic or aperiodic. For example, a UE may periodically reserve one or more sidelink resources, such as by indicating a reservation period in SCI or in one part of the SCI (e.g., in SCI-1 of a two-stage SCI as discussed in details in FIG. 11). Thus, when the periodic resource reservation is enabled for a UE, the reservations in the SCI may be repeated with the signaled period. In some examples, a reservation period for the periodic resource reservation may be configured to values between 0 ms and 1000 ms by signaling in the SCI, and the periodic resource reservation may also be disabled by a (pre-)configuration. In other examples, each resource reservation may be associated with a priority level indicated in the SCI. A resource reservation associated with a higher priority level may preempt a resource reservation associated with a lower priority level. Similarly, resource(s) used by a UE for transmitting inter-UE coordination information may also configured to be periodic (e.g., based on semi-persistent scheduling (SPS)) or aperiodic (e.g., based on collision triggered by another UE, such as the UE receiving the inter-UE coordination information). For example, referring back to FIG. 8, the first UE 702 may reserve sub-channel m+1 (SC m+1) at every six slots (e.g., at slot n, slot n+6, slot n+12, etc.) for transmitting inter-UE coordination information.

In some examples, a resource reservation may be indicated by a transmitting UE in multiple SCI parts, where the SCI may indicate resources in which the UE is using for a sidelink transmission. For example, a UE may transmit a first part of the reservation in a PSCCH, and may transmit a second part of the reservation in a PSSCH. In other words, a first stage control information (e.g., SCI-1) may be transmitted on a PSCCH and may contain resource allocation and information related to the decoding of a second stage control information (e.g., SCI-2), and the second stage control information may be transmitted on a corresponding PSSCH and may contain information for decoding the data (SCH) in the PSSCH. Therefore, multiple resources may be indicated, or reserved, through a combination of the first SCI part indicated in the PSCCH region and the second SCI part in the PSSCH region. For example, the first SCI part in the PSCCH may reserve resources for a UE in a PSSCH, and the first SCI part may also indicate to a receiving UE that there is a second SCI part or more (e.g., Two-stage SCI) in the PSSCH. The second SCI part may reserve other resources or provide signaling and/or information to the UE which may be unrelated to the resources reserved in the first SCI part.

FIG. 11 is a diagram 1100 illustrating an example of a two-stage SCI in accordance with various aspects of the present disclosure. To reduce control overhead and to improve the processing timeline, SCI used for sidelink grant(s) may split into two parts or more. For example, a first SCI part 1102 may be transmitted within the control region (e.g., the PSCCH region 1108) and a second SCI part 1104 may be transmitted within the downlink traffic region (e.g., the PSSCH region 1110). The PSCCH region 1108 and the PSSCH region 1110 may together form one slot. The first SCI part 1102 may include initial control information regarding a sidelink transmission, such as the resource assignment (RA) in SCH 1106 or other resource reservation information, rank and modulation order of the sidelink assignment, etc. In addition, the first SCI part 1102 may also include control information about the second SCI part 1104. In some examples, the control information may indicate the number of resource elements (size) and code rate of the second SCI part 1104. The control information may further indicate the location (e.g., starting resource element) and code rate of the second SCI part 1104. The second SCI part 1104 may include the remaining control information regarding the sidelink assignment. For example, the remaining control information may include non-time critical control information or other resource allocation for data transmission in SCH 1106, such as the source and destination ID for the data transmission. In one aspect, the first SCI part 1102 (e.g., SCI-1) format may include one or more of the following: a priority (e.g., a QoS value), a PSSCH resource assignment (e.g., frequency/time resource for PSSCH), a resource reservation period (e.g., if enabled), a PSSCH DMRS pattern (e.g., if more than one patterns are configured), a second SCI format (e.g., information on the size of the second SCI), a 2-bit beta offset for second stage control resource allocation, number of PSSCH DMRS port(s) (e.g., 1 or 2), a 5-bit MCS and/or reserved bits, etc.

In one aspect of the present disclosure, when a UE reserves one or more resources for inter-UE coordination information transmission, the UE may indicate the reserved resource(s) with a new or modified first stage SCI format (e.g., a modified SCI-1) and/or a new or modified second stage SCI format (e.g., a modified SCI-2). For example, for inter-UE coordination information transmission based on dedicated resources, such as described in connection with FIGS. 7 and 8, a UE may use a new or modified first stage SCI format and/or a new or modified second stage SCI format that excludes resource reservation information as the UE may transmit the inter-UE coordination information without performing a resource sensing. This may reduce the signalling overhead for the SCI and improve the reliability and the speed of the sidelink communication.

In another example, for inter-UE coordination messages, as packets information may be different over transmissions (e.g., the suitable or non-suitable resources indicated in the inter-UE coordination messages may be updated from time to time in different transmissions), a UE may be configured to skip retransmissions for inter-UE coordination messages. In other words, re-transmission of the “same packet” may be disabled for inter-UE coordination information transmission. For example, referring back to FIG. 5, if the first UE is configured to transmit a sidelink transmission at 502 that includes a data and an inter-UE coordination message, the first UE may retransmit the sidelink transmission at 504 and/or 506. However, the first UE may be configured to retransmit the data without the inter-UE coordination message at 504 and/or 506 as resource information in the inter-UE coordination message may not be updated or may have changed.

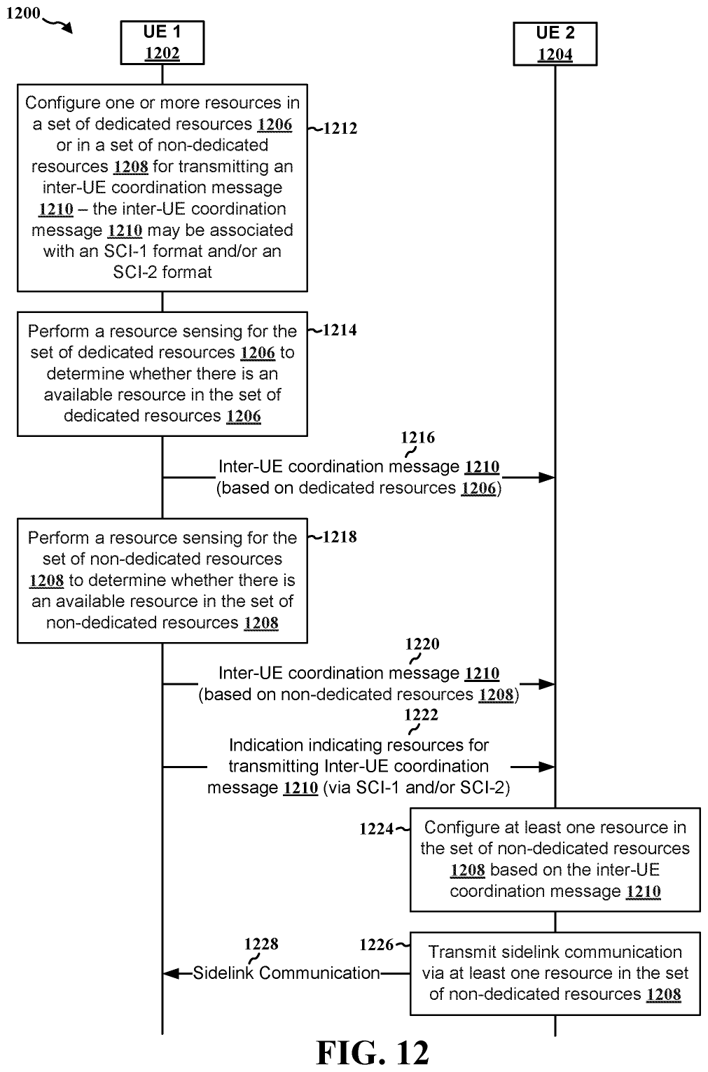

FIG. 12 is a communication flow 1200 illustrating an example of transmitting inter-UE coordination information and/or reserving one or more resources for inter-UE coordination information in accordance with various aspects of the present disclosure. The numberings associated with the communication flow 1200 do not specify a particular temporal order and are merely used as references for the communication flow 1200.

At 1212, a first UE 1202 (e.g., the first UE 602, 702, 902) may configure (e.g., select, reserve, determine, etc.) one or more resources in a set of dedicated resources 1206 or in a set of non-dedicated resources 1208 for a transmission of an inter-UE coordination message 1210, such as described in connection with FIGS. 7 to 9, 10A, and 10B. The inter-UE coordination message being associated with at least one of a first stage SCI format or a second stage SCI format, such as described in connection with FIG. 11. In one example, the one or more resources may correspond to one or more resources that are suitable for sidelink communication from another UE (e.g., the second UE 1204). In another example, the one or more resources may correspond to one or more resources that are not suitable for sidelink communication from another UE (e.g., the second UE 1204). For examples, resources that are suitable for sidelink communication may be resources that have measured RSRP below a threshold, resources with less measured interference, resources that do not collide with other communication frequency (e.g., frequency used by other types of wireless device), etc.

At 1214, the first UE 1202 may perform a resource sensing for the set of dedicated resources 1206 to determine whether any resources in the set of dedicated resources 1206 are available for transmission. In one example, the set of dedicated resources 1206 may correspond to at least one sub-channel in at least one slot, such as described in connection with FIG. 7. In another example, the set of dedicated resources 1206 may correspond to at least one sub-channel in every X slots, where X may be an integer greater than or equal to two, such as described in connection with FIG. 8.

At 1216, in one example, if the first UE 1202 determines that one or more resources in the dedicated resources 1206 are available for transmission, the first UE 1202 may transmit or broadcast the inter-UE coordination message 1210 to one or more UEs via the one or more resources in the dedicated resources 1206, such as to UEs within its transmission range including a second UE 1204. However, if the first UE 1202 determines that there are no available resources in the dedicated resources 1206, the first UE 1202 may skip the transmission of the inter-UE coordination message 1210. In another example, the first UE 1202 may transmit or broadcast the inter-UE coordination message 1210 to one or more UEs using one or more resources selected from the set of dedicated resources 1206 without performing the resource sensing (e.g., as shown at 1214) to reduce inter-UE coordination information transmission latency, such as described in connection with FIG. 7.

At 1218, the first UE 1202 may perform a resource sensing for the set of non-dedicated resources 1208 to determine whether any resources in the set of non-dedicated resources 1208 are available for transmission. In one example, the first UE 1202 may perform the resource sensing for the set of non-dedicated resources 1208 if the set of dedicated resources 1206 does not have resources available for transmitting the inter-UE coordination message 1210. In another example, the first UE 1202 may perform the resource sensing for the set of non-dedicated resources 1208 if there are no dedicated resources for the inter-UE coordination message 1210 (e.g., the resource pool is not configured with dedicated resources for inter-UE coordination messages).

At 1220, if the first UE 1202 determines that one or more resources in the non-dedicated resources 1208 are available for transmission, the first UE 1202 may transmit or broadcast the inter-UE coordination message 1210 to one or more UEs via the one or more resources in the non-dedicated resources 1208, such as to UEs within its transmission range including the second UE 1204. However, if the first UE 1202 determines that there are no available resources in the non-dedicated resources 1208, the first UE 1202 may skip the transmission of the inter-UE coordination message 1210. In another example, the inter-UE coordination message 1210 may be associated or configured with a transmission priority that is lower than a PSCCH, a PSSCH, and/or a PSFCH if the inter-UE coordination message is transmitted using resource(s) in the non-dedicated resources 1208. Thus, if the inter-UE coordination message 1210 is scheduled to be transmitted in a same resource as a PSCCH, a PSSCH, or a PSFCH, the PSCCH, the PSSCH, or the PSFCH may have transmission priority over the inter-UE coordination message 1210 (e.g., the transmission of the inter-UE coordination message 1210 may be skipped or preempted).

In another example, the first UE 1202 may perform a resource sensing for the set of dedicated resources 1206 or the set of non-dedicated resources 1208 based on an RSRP threshold to determine an available resource ratio for the set of dedicated resources 1206 or the set of non-dedicated resources 1208, such as described in connection with FIGS. 10A and 10B. In such an example, the first UE 1202 may transmit/broadcast the inter-UE coordination message 1216 via one or more resources in the set of dedicated resources 1206 or in the set of non-dedicated resources 1208 based on the available resource ratio meeting a percentage threshold. In such an example, the first UE 1202 may receive a configuration for the RSRP threshold and/or the percentage threshold from a base station. In addition, in some examples, the first UE 1202 may be configured to modify the RSRP threshold if the available resource ratio for the set of dedicated resources or the set of non-dedicated resources does not meet the percentage threshold. In such examples, the first UE 1202 may modify the RSRP threshold until the available resource ratio meets the percentage threshold or until a defined maximum number of times in which the first UE 1202 may modify the RSRP threshold is met.

At 1222, the first UE 1202 may transmit or broadcast an indication to one or more UEs (including the second UE 1204) indicating the resource(s) in which the inter-UE coordination message 1210 is to be transmitted (e.g., resource(s) selected from the set of dedicated resources 1206 or in the set of non-dedicated resources 1208, etc.). The first UE 1202 may transmit or broadcast the indication via the associated first stage SCI format or the associated second stage SCI format, such as described in connection with FIG. 11. The resource(s) in which the inter-UE coordination message 1210 is to be transmitted may be periodic resources or aperiodic resources. In one example, at least one of the first stage SCI format or the second stage SCI format may be adjusted by the first UE 1202 after the first UE 1202 transmits the inter-UE coordination message 1210. For example, the first stage SCI format or the second stage SCI format may be configured by the first UE 1202 to not include a resource reservation information if the inter-UE coordination message 1210 is transmitted via the one or more resources in the set of dedicated resources 1206 without the first UE 1202 performing a resource sensing. In another example, the first UE 1202 may be configured to skip transmitting the inter-UE coordination message 1210 in a retransmission. In another example, the first UE 1202 may exclude retransmission related information from the first stage SCI format and/or the second stage SCI format if the inter-UE coordination message 1210 is transmitted. For example, retransmission related information may include redundancy version (RV) and/or new data indicator (NDI), etc. that are associated with a retransmission, which may be indicated by the first UE 1202 in an SCI-2 format.

At 1224, if the second UE 1204 receives the inter-UE coordination message 1210 from the first UE 1202 via one or more resources in the set of dedicated resources 1206 or in the set of non-dedicated resources 1208, the second UE 1204 may configure (e.g., select, reserve, etc.) at least one resource in the set of non-dedicated resources 1208 for sidelink communication based at least in part on the inter-UE coordination message 1210. For example, if the inter-UE coordination message 1210 indicates resources in which the second UE 1204 may use for sidelink communication, the second UE 1204 may select one or more resources from the indicated resources for performing a sidelink transmission. If the inter-UE coordination message 1210 indicates resources in which the second UE 1204 may not use for sidelink communication, the second UE 1204 may select one or more resources other than the indicated resources for performing a sidelink transmission.

At 1226, the second UE 1204 may transmit sidelink communication via the configured resource(s) in the set of non-dedicated resources 1208. For example, as shown at 1228, the second UE 1204 may transmit sidelink communication to the first UE 1202 via the configured resource(s) in the set of non-dedicated resources 1208.

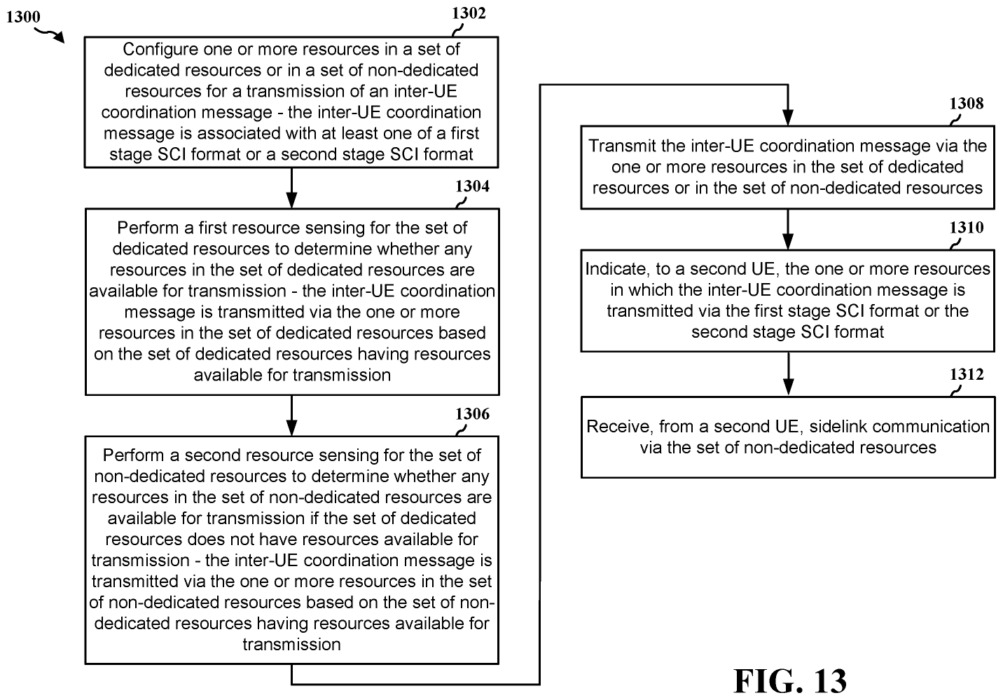

FIG. 13 is a flowchart 1300 of a method of wireless communication. The method may be performed by a UE or a component of a UE (e.g., the UE 104, 350; the first UE 602, 702, 902, 1202; the apparatus 1502; a processing system, which may include the memory 360 and which may be the entire UE 350 or a component of the UE 350, such as the TX processor 368, the RX processor 356, and/or the controller/processor 359). The method may enable the UE to transmit or broadcast inter-UE coordination information to one or more UEs based on a set of dedicated-resources or a set of non-dedicated resources.

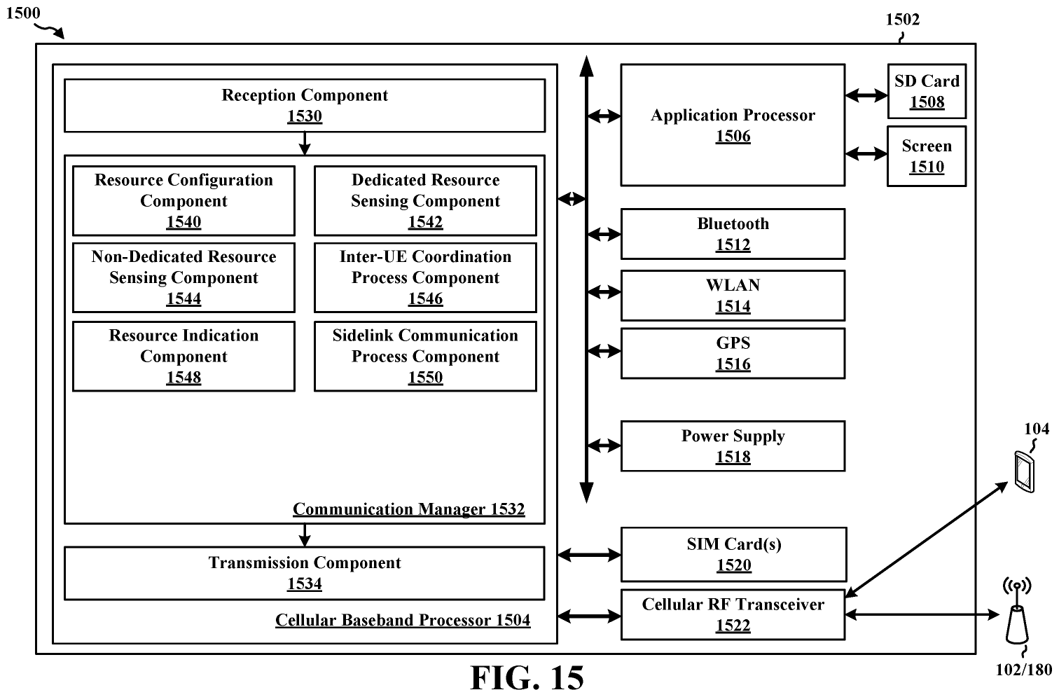

At 1302, a first UE may configure one or more resources in a set of dedicated resources or in a set of non-dedicated resources for a transmission of an inter-UE coordination message, the inter-UE coordination message may be associated with at least one of a first stage SCI format or a second stage SCI format, such as described in connection with FIG. 12. For example, at 1212, the first UE 1202 may configure one or more resources in a set of dedicated resources 1206 or in a set of non-dedicated resources 1208 for transmitting an inter-UE coordination message 1210, where the inter-UE coordination message 1210 may be associated with an SCI-1 format and/or an SCI-2 format. The configuration of the one or more resources may be performed by, e.g., the resource configuration component 1540 of the apparatus 1502 in FIG. 15.

In one example, the set of dedicated resources may correspond to at least one sub-channel in at least one slot. In another example, the set of dedicated resources may correspond to at least one sub-channel in every X slots, where X may be an integer greater than or equal to two.

In another example, as described in connection with FIGS. 7 and 8, the inter-UE coordination message may be transmitted via the one or more resources in the set of dedicated resources, and the inter-UE coordination message may be transmitted without the first UE performing a resource sensing for the set of dedicated resources.

In another example, the one or more resources may correspond to one or more resources that are suitable for sidelink communication from a second UE, or one or more resources that are not suitable for sidelink communication from the second UE.

At 1304, the first UE may perform a first resource sensing for the set of dedicated resources to determine whether any resources in the set of dedicated resources are available for transmission, where the inter-UE coordination message may be transmitted via the one or more resources in the set of dedicated resources based on the set of dedicated resources having resources available for transmission, such as described in connection with FIG. 12. For example, at 1214, the first UE 1202 may perform a resource sensing for the set of dedicated resources 1206 to determine whether there is an available resource in the set of dedicated resources 1206. Then, at 1216, the first UE 1202 may transmit the inter-UE coordination message 1210 based on the dedicated resources 1206. The first resource sensing for the set of dedicated resources may be performed by, e.g., the dedicated resource sensing component 1542 and/or the reception component 1530 of the apparatus 1502 in FIG. 15.

In one example, the first UE may skip the transmission of the inter-UE coordination message if the set of dedicated resources does not have resources available for transmission.

At 1306, the first UE may perform a second resource sensing for the set of non-dedicated resources to determine whether any resources in the set of non-dedicated resources are available for transmission if the set of dedicated resources does not have resources available for transmission, where the inter-UE coordination message may be transmitted via the one or more resources in the set of non-dedicated resources based on the set of non-dedicated resources having resources available for transmission, such as described in connection with FIG. 12. For example, at 1218, the first UE 1202 may perform a resource sensing for the set of non-dedicated resources 1208 to determine whether there is an available resource in the set of non-dedicated resources 1208. Then, at 1220, the first UE 1202 may transmit the inter-UE coordination message 1210 based on the non-dedicated resource 1208. The second resource sensing for the set of non-dedicated resources may be performed by, e.g., the non-dedicated resource sensing component 1544 and/or the reception component 1530 of the apparatus 1502 in FIG. 15.

In one example, the first UE may perform a resource sensing for the set of dedicated resources or the set of non-dedicated resources based on an RSRP threshold to determine an available resource ratio for the set of dedicated resources or the set of non-dedicated resources, and the inter-UE coordination message may be transmitted via the one or more resources in the set of dedicated resources or the set of non-dedicated resources based on the available resource ratio meeting a percentage threshold. In such an example, the first UE may receive, from a base station, a configuration for the percentage threshold. In such an example, the first UE may modify the RSRP threshold if the available resource ratio for the set of dedicated resources or the set of non-dedicated resources does not meet the percentage threshold. In such an example, the first UE may receive, from a base station, a configuration for a maximum number of times in which the RSRP threshold can be modified.

At 1308, the first UE may transmit the inter-UE coordination message via the one or more resources in the set of dedicated resources or in the set of non-dedicated resources, such as described in connection with FIG. 12. For example, at 1216, the first UE 1202 may transmit the inter-UE coordination message 1210 based on the dedicated resources 1206, or at 1220, the first UE 1202 may transmit the inter-UE coordination message 1210 based on the non-dedicated resource 1208. The transmission of the inter-UE coordination message may be performed by, e.g., the inter-UE coordination process component 1546 and/or the transmission component 1534 of the apparatus 1502 in FIG. 15. The inter-UE coordination message may be a broadcast message.

In one example, the inter-UE coordination message may be associated with a transmission priority that is lower than a PSCCH, a PSSCH, and/or a PSFCH if the inter-UE coordination message is transmitted via the one or more resources in the set of non-dedicated resources.

In another example, the first UE may skip transmitting the inter-UE coordination message in a retransmission.

At 1310, the first UE may indicate, to a second UE, the one or more resources in which the inter-UE coordination message is transmitted via the first stage SCI format or the second stage SCI format, such as described in connection with FIG. 12. For example, at 1222, the first UE 1202 may transmit an indication indicating resources for transmitting the inter-UE coordination message 1210 via SCI-1 and/or SCI-2. The indication of the one or more resources may be performed by, e.g., the resource indication component 1548 and/or the transmission component 1534 of the apparatus 1502 in FIG. 15. In one example, the one or more resources may be periodic resources or aperiodic resources.

In one example, the first stage SCI format or the second stage SCI format may not include a resource reservation information if the inter-UE coordination message is transmitted via the one or more resources in the set of dedicated resources.

In another example, at least one of the first stage SCI format or the second stage SCI format may be adjusted after the inter-UE coordination message is transmitted. One example of adjustment on SCI format is: no retransmission related info is included with inter-UE coordination (e.g., RV, NDI may be indicated in an SCI-2 format if there is a retransmission).

At 1312, the first UE may receive, from a second UE, sidelink communication via the set of non-dedicated resources, such as described in connection with FIG. 12. For example, at 1228, the first UE 1202 may receive sidelink communication from the second UE 1204 via the set of non-dedicated resources 1208. The reception of the sidelink communication may be performed by, e.g., the sidelink communication process component 1550 and/or the reception component 1530 of the apparatus 1502 in FIG. 15.

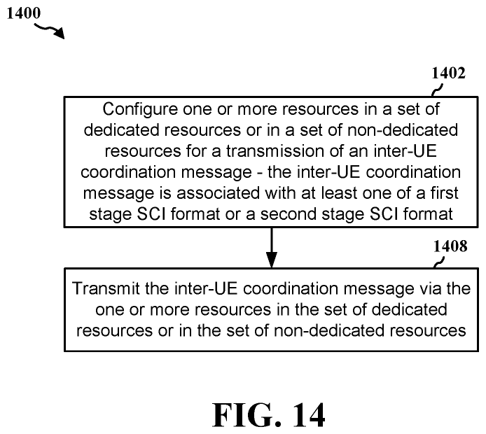

FIG. 14 is a flowchart 1400 of a method of wireless communication. The method may be performed by a UE or a component of a UE (e.g., the UE 104, 350; the first UE 602, 702, 902, 1202; the apparatus 1502; a processing system, which may include the memory 360 and which may be the entire UE 350 or a component of the UE 350, such as the TX processor 368, the RX processor 356, and/or the controller/processor 359). The method may enable the UE to transmit or broadcast inter-UE coordination information to one or more UEs based on a set of dedicated-resources or a set of non-dedicated resources.

At 1402, a first UE may configure one or more resources in a set of dedicated resources or in a set of non-dedicated resources for a transmission of an inter-UE coordination message, the inter-UE coordination message may be associated with at least one of a first stage SCI format or a second stage SCI format, such as described in connection with FIG. 12. For example, at 1212, the first UE 1202 may configure one or more resources in a set of dedicated resources 1206 or in a set of non-dedicated resources 1208 for transmitting an inter-UE coordination message 1210, where the inter-UE coordination message 1210 may be associated with an SCI-1 format and/or an SCI-2 format. The configuration of the one or more resources may be performed by, e.g., the resource configuration component 1540 of the apparatus 1502 in FIG. 15.

In one example, the set of dedicated resources may correspond to at least one sub-channel in at least one slot. In another example, the set of dedicated resources may correspond to at least one sub-channel in every X slots, where X may be an integer greater than or equal to two.

In another example, as described in connection with FIGS. 7 and 8, the inter-UE coordination message may be transmitted via the one or more resources in the set of dedicated resources, and the inter-UE coordination message may be transmitted without the first UE performing a resource sensing for the set of dedicated resources.

In another example, the one or more resources may correspond to one or more resources that are suitable for sidelink communication from a second UE, or one or more resources that are not suitable for sidelink communication from the second UE.

At 1408, the first UE may transmit the inter-UE coordination message via the one or more resources in the set of dedicated resources or in the set of non-dedicated resources, such as described in connection with FIG. 12. For example, at 1216, the first UE 1202 may transmit the inter-UE coordination message 1210 based on the dedicated resources 1206, or at 1220, the first UE 1202 may transmit the inter-UE coordination message 1210 based on the non-dedicated resource 1208. The transmission of the inter-UE coordination message may be performed by, e.g., the inter-UE coordination process component 1546 and/or the transmission component 1534 of the apparatus 1502 in FIG. 15. The inter-UE coordination message may be a broadcast message.

In one example, the first UE may perform a first resource sensing for the set of dedicated resources to determine whether any resources in the set of dedicated resources are available for transmission, where the inter-UE coordination message may be transmitted via the one or more resources in the set of dedicated resources based on the set of dedicated resources having resources available for transmission, such as described in connection with FIG. 12. For example, at 1214, the first UE 1202 may perform a resource sensing for the set of dedicated resources 1206 to determine whether there is an available resource in the set of dedicated resources 1206. Then, at 1216, the first UE 1202 may transmit the inter-UE coordination message 1210 based on the dedicated resources 1206. The first resource sensing for the set of dedicated resources may be performed by, e.g., the dedicated resource sensing component 1542 and/or the reception component 1530 of the apparatus 1502 in FIG. 15.

In another example, the first UE may skip the transmission of the inter-UE coordination message if the set of dedicated resources does not have resources available for transmission.

In another example, the first UE may perform a second resource sensing for the set of non-dedicated resources to determine whether any resources in the set of non-dedicated resources are available for transmission if the set of dedicated resources does not have resources available for transmission, where the inter-UE coordination message may be transmitted via the one or more resources in the set of non-dedicated resources based on the set of non-dedicated resources having resources available for transmission, such as described in connection with FIG. 12. For example, at 1218, the first UE 1202 may perform a resource sensing for the set of non-dedicated resources 1208 to determine whether there is an available resource in the set of non-dedicated resources 1208. Then, at 1220, the first UE 1202 may transmit the inter-UE coordination message 1210 based on the non-dedicated resource 1208. The second resource sensing for the set of non-dedicated resources may be performed by, e.g., the non-dedicated resource sensing component 1544 and/or the reception component 1530 of the apparatus 1502 in FIG. 15.

In another example, the first UE may perform a resource sensing for the set of dedicated resources or the set of non-dedicated resources based on an RSRP threshold to determine an available resource ratio for the set of dedicated resources or the set of non-dedicated resources, and the inter-UE coordination message may be transmitted via the one or more resources in the set of dedicated resources or the set of non-dedicated resources based on the available resource ratio meeting a percentage threshold. In such an example, the first UE may receive, from a base station, a configuration for the percentage threshold. In such an example, the first UE may modify the RSRP threshold if the available resource ratio for the set of dedicated resources or the set of non-dedicated resources does not meet the percentage threshold. In such an example, the first UE may receive, from a base station, a configuration for a maximum number of times in which the RSRP threshold can be modified.

In another example, the inter-UE coordination message may be associated with a transmission priority that is lower than a PSCCH, a PSSCH, and/or a PSFCH if the inter-UE coordination message is transmitted via the one or more resources in the set of non-dedicated resources.

In another example, the first UE may skip transmitting the inter-UE coordination message in a retransmission.

In another example, the first UE may indicate, to a second UE, the one or more resources in which the inter-UE coordination message is transmitted via the first stage SCI format or the second stage SCI format, such as described in connection with FIG. 12. For example, at 1222, the first UE 1202 may transmit an indication indicating resources for transmitting the inter-UE coordination message 1210 via SCI-1 and/or SCI-2. The indication of the one or more resources may be performed by, e.g., the resource indication component 1548 and/or the transmission component 1534 of the apparatus 1502 in FIG. 15. In one example, the one or more resources may be periodic resources or aperiodic resources.

In another example, the first stage SCI format or the second stage SCI format may not include a resource reservation information if the inter-UE coordination message is transmitted via the one or more resources in the set of dedicated resources.

In another example, at least one of the first stage SCI format or the second stage SCI format may be adjusted after the inter-UE coordination message is transmitted.

In another example, the first UE may receive, from a second UE, sidelink communication via the set of non-dedicated resources, such as described in connection with FIG. 12. For example, at 1228, the first UE 1202 may receive sidelink communication from the second UE 1204 via the set of non-dedicated resources 1208. The reception of the sidelink communication may be performed by, e.g., the sidelink communication process component 1550 and/or the reception component 1530 of the apparatus 1502 in FIG. 15.

FIG. 15 is a diagram 1500 illustrating an example of a hardware implementation for an apparatus 1502. The apparatus 1502 may be a UE, a component of a UE, or may implement UE functionality. In some aspects, the apparatus 1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, or a power supply 1518. The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 includes a resource configuration component 1540 that is configured to configure one or more resources in a set of dedicated resources or in a set of non-dedicated resources for a transmission of an inter-UE coordination message, the inter-UE coordination message being associated with at least one of a first stage SCI format or a second stage SCI format, e.g., as described in connection with 1302 of FIGS. 13 and/or 1402 of FIG. 14. The communication manager 1532 further includes a dedicated resource sensing component 1542 that is configured to perform a first resource sensing for the set of dedicated resources to determine whether any resources in the set of dedicated resources are available for transmission, where the inter-UE coordination message is transmitted via the one or more resources in the set of dedicated resources based on the set of dedicated resources having resources available for transmission, e.g., as described in connection with 1304 of FIG. 13. The communication manager 1532 further includes a non-dedicated resource sensing component 1544 that is configured to perform a second resource sensing for the set of non-dedicated resources to determine whether any resources in the set of non-dedicated resources are available for transmission if the set of dedicated resources does not have resources available for transmission, where the inter-UE coordination message is transmitted via the one or more resources in the set of non-dedicated resources based on the set of non-dedicated resources having resources available for transmission, e.g., as described in connection with 1306 of FIG. 13. The communication manager 1532 further includes an inter-UE coordination process component 1546 that is configured to transmit the inter-UE coordination message via the one or more resources in the set of dedicated resources or in the set of non-dedicated resources, e.g., as described in connection with 1308 of FIGS. 13 and/or 1408 of FIG. 14. The communication manager 1532 further includes a resource indication component 1548 that is configured to indicate, to a second UE, the one or more resources in which the inter-UE coordination message is transmitted via the first stage SCI format or the second stage SCI format, e.g., as described in connection with 1310 of FIG. 13. The communication manager 1532 further includes a sidelink communication process component 1550 that is configured to receive, from a second UE, sidelink communication via the set of non-dedicated resources, e.g., as described in connection with 1312 of FIG. 13.

The apparatus may include additional components that perform each of the blocks of the algorithm in the flowcharts of FIGS. 13 and 14. As such, each block in the flowcharts of FIGS. 13 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, includes means for configuring one or more resources in a set of dedicated resources or in a set of non-dedicated resources for a transmission of an inter-UE coordination message, the inter-UE coordination message being associated with at least one of a first stage SCI format or a second stage SCI format (e.g., the resource configuration component 1540). The apparatus 1502 includes means for performing a first resource sensing for the set of dedicated resources to determine whether any resources in the set of dedicated resources are available for transmission, where the inter-UE coordination message is transmitted via the one or more resources in the set of dedicated resources based on the set of dedicated resources having resources available for transmission (e.g., the dedicated resource sensing component 1542 and/or the reception component 1530). The apparatus 1502 includes means for performing a second resource sensing for the set of non-dedicated resources to determine whether any resources in the set of non-dedicated resources are available for transmission if the set of dedicated resources does not have resources available for transmission, where the inter-UE coordination message is transmitted via the one or more resources in the set of non-dedicated resources based on the set of non-dedicated resources having resources available for transmission (e.g., the non-dedicated resource sensing component 1544 and/or the reception component 1530). The apparatus 1502 includes means for transmitting the inter-UE coordination message via the one or more resources in the set of dedicated resources or in the set of non-dedicated resources (e.g., the inter-UE coordination process component 1546 and/or the transmission component 1534). The apparatus 1502 includes means for indicating, to a second UE, the one or more resources in which the inter-UE coordination message is transmitted via the first stage SCI format or the second stage SCI format (e.g., the resource indication component 1548 and/or the transmission component 1534). The apparatus 1502 includes means for receiving, from a second UE, sidelink communication via the set of non-dedicated resources (e.g., the sidelink communication process component 1550 and/or the reception component 1530).

In one configuration, the set of dedicated resources may correspond to at least one sub-channel in at least one slot. In another configuration, the set of dedicated resources may correspond to at least one sub-channel in every X slots, where X may be an integer greater than or equal to two.

In another configuration, the inter-UE coordination message may be transmitted via the one or more resources in the set of dedicated resources, and the inter-UE coordination message may be transmitted without the first UE performing a resource sensing for the set of dedicated resources.

In another configuration, the one or more resources may correspond to one or more resources that are suitable for sidelink communication from a second UE, or one or more resources that are not suitable for sidelink communication from the second UE.

In another configuration, the apparatus 1502 includes means for skipping the transmission of the inter-UE coordination message if the set of dedicated resources does not have resources available for transmission.

In another configuration, the apparatus 1502 includes means for performing a resource sensing for the set of dedicated resources or the set of non-dedicated resources based on an RSRP threshold to determine an available resource ratio for the set of dedicated resources or the set of non-dedicated resources, and the inter-UE coordination message may be transmitted via the one or more resources in the set of dedicated resources or the set of non-dedicated resources based on the available resource ratio meeting a percentage threshold. In such a configuration, the apparatus 1502 includes means for receiving, from a base station, a configuration for the percentage threshold. In such a configuration, the apparatus 1502 includes means for modifying the RSRP threshold if the available resource ratio for the set of dedicated resources or the set of non-dedicated resources does not meet the percentage threshold. In such a configuration, the apparatus 1502 includes means for receiving, from a base station, a configuration for a maximum number of times in which the RSRP threshold can be modified.

In another configuration, the inter-UE coordination message may be associated with a transmission priority that is lower than a PSCCH, a PSSCH, and/or a PSFCH if the inter-UE coordination message is transmitted via the one or more resources in the set of non-dedicated resources.

In another configuration, the apparatus 1502 includes means for skipping transmitting the inter-UE coordination message in a retransmission.

In another configuration, the first stage SCI format or the second stage SCI format may not include a resource reservation information if the inter-UE coordination message is transmitted via the one or more resources in the set of dedicated resources.

In another configuration, at least one of the first stage SCI format or the second stage SCI format may be adjusted after the inter-UE coordination message is transmitted.

The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

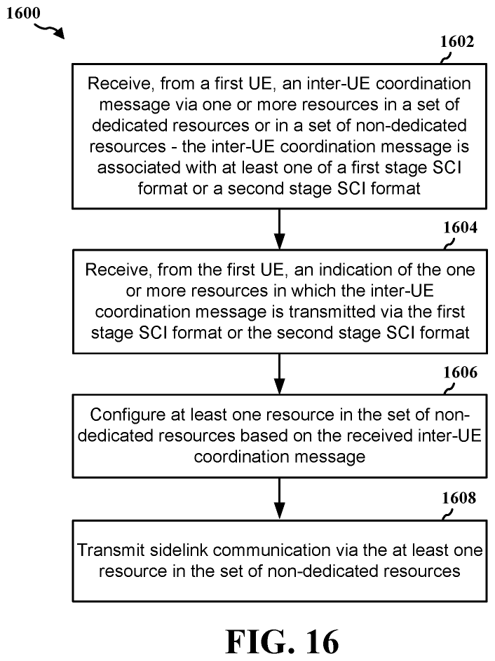

FIG. 16 is a flowchart 1600 of a method of wireless communication. The method may be performed by a UE or a component of a UE (e.g., the UE 104, 350; the second UE 604, 704, 904, 1204; the apparatus 1802; a processing system, which may include the memory 360 and which may be the entire UE 350 or a component of the UE 350, such as the TX processor 368, the RX processor 356, and/or the controller/processor 359). The method may enable the UE to transmit, reserve and/or schedule sidelink transmissions based at least in part on inter-UE coordination information received from other UE(s).

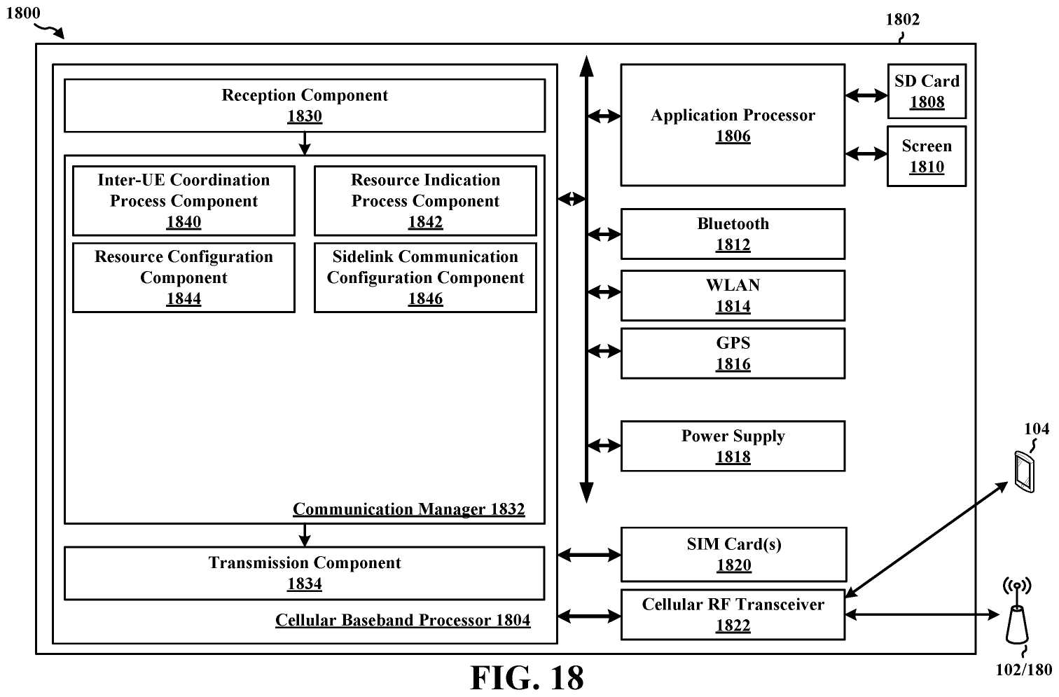

At 1602, a second UE may receive, from a first UE, an inter-UE coordination message via one or more resources in a set of dedicated resources or in a set of non-dedicated resources, the inter-UE coordination message may be associated with at least one of a first stage SCI format or a second stage SCI format, such as described in connection with FIG. 12. For example, at 1216, the second UE 1204 may receive the inter-UE coordination message 1210 from the first UE 1202 based on the dedicated resources 1206, or at 1220, the second UE 1204 may receive the inter-UE coordination message 1210 from the first UE 1202 based on the non-dedicated resources 1208. The reception of the inter-UE coordination message may be performed by, e.g., the inter-UE coordination process component 1840 and/or the reception component 1830 of the apparatus 1802 in FIG. 18. The inter-UE coordination message may be a broadcast message.

In one example, the set of dedicated resources may correspond to at least one sub-channel in at least one slot. In another example, the set of dedicated resources correspond to at least one sub-channel in every X slots, where X may be an integer greater than or equal to two.

In another example, the inter-UE coordination message may be associated with a transmission priority that is lower than a PSCCH, a PSSCH, or a PSFCH if the inter-UE coordination message is transmitted via the one or more resources in the set of non-dedicated resources.

In another example, the first stage SCI format or the second stage SCI format may not include a resource reservation information if the inter-UE coordination message is received via the one or more resources in the set of dedicated resources.

At 1604, the second UE may receive, from the first UE, an indication of the one or more resources in which the inter-UE coordination message is transmitted via the first stage SCI format or the second stage SCI format, such as described in connection with FIG. 12. For example, at 1222, the second UE 1204 may receive an indication from the first UE 1202 indicating resources in which the inter-UE coordination message 1210 is transmitted via the first stage SCI format or the second stage SCI format. The reception of the indication may be performed by, e.g., the resource indication process component 1842 and/or the reception component 1830 of the apparatus 1802 in FIG. 18. The one or more resources may be periodic resources or aperiodic resources.

At 1606, the second UE may configure at least one resource in the set of non-dedicated resources based on the received inter-UE coordination message, such as described in connection with FIG. 12. For example, at 1224, the second UE 1204 may configure at least one resource in the set of non-dedicated resources 1208 based on the inter-UE coordination message 1210. The configuration of the at least one resource in the set of non-dedicated resources may be performed by, e.g., the resource configuration component 1844 of the apparatus 1802 in FIG. 18.

At 1608, the second UE may transmit sidelink communication via the at least one resource in the set of non-dedicated resources, such as described in connection with FIG. 12. For example, at 1226, the second UE 1204 may transmit sidelink communication via at least one resource in the set of non-dedicated resources 1208. The transmission of the sidelink communication may be performed by, e.g., the sidelink communication configuration component 1846 and/or the transmission component 1834 of the apparatus 1802 in FIG. 18.

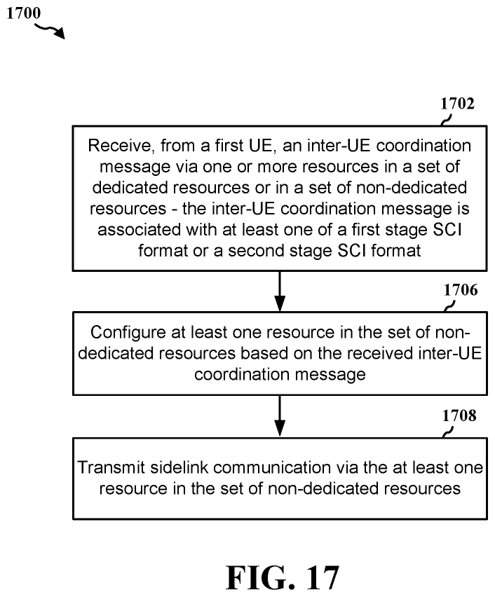

FIG. 17 is a flowchart 1700 of a method of wireless communication. The method may be performed by a UE or a component of a UE (e.g., the UE 104, 350; the second UE 604, 704, 904, 1204; the apparatus 1802; a processing system, which may include the memory 360 and which may be the entire UE 350 or a component of the UE 350, such as the TX processor 368, the RX processor 356, and/or the controller/processor 359). The method may enable the UE to transmit, reserve and/or schedule sidelink transmissions based at least in part on inter-UE coordination information received from other UE(s).

At 1702, a second UE may receive, from a first UE, an inter-UE coordination message via one or more resources in a set of dedicated resources or in a set of non-dedicated resources, the inter-UE coordination message may be associated with at least one of a first stage SCI format or a second stage SCI format, such as described in connection with FIG. 12. For example, at 1217, the second UE 1204 may receive the inter-UE coordination message 1210 from the first UE 1202 based on the dedicated resources 1206, or at 1220, the second UE 1204 may receive the inter-UE coordination message 1210 from the first UE 1202 based on the non-dedicated resources 1208. The reception of the inter-UE coordination message may be performed by, e.g., the inter-UE coordination process component 1840 and/or the reception component 1830 of the apparatus 1802 in FIG. 18. The inter-UE coordination message may be a broadcast message.

In one example, the set of dedicated resources may correspond to at least one sub-channel in at least one slot. In another example, the set of dedicated resources correspond to at least one sub-channel in every X slots, where X may be an integer greater than or equal to two.

In another example, the inter-UE coordination message may be associated with a transmission priority that is lower than a PSCCH, a PSSCH, or a PSFCH if the inter-UE coordination message is transmitted via the one or more resources in the set of non-dedicated resources.

In another example, the first stage SCI format or the second stage SCI format may not include a resource reservation information if the inter-UE coordination message is received via the one or more resources in the set of dedicated resources.

In another example, the second UE may receive, from the first UE, an indication of the one or more resources in which the inter-UE coordination message is transmitted via the first stage SCI format or the second stage SCI format, such as described in connection with FIG. 12. For example, at 1222, the second UE 1204 may receive an indication from the first UE 1202 indicating resources in which the inter-UE coordination message 1210 is transmitted via the first stage SCI format or the second stage SCI format. The reception of the indication may be performed by, e.g., the resource indication process component 1842 and/or the reception component 1830 of the apparatus 1802 in FIG. 18. The one or more resources may be periodic resources or aperiodic resources.

At 1706, the second UE may configure at least one resource in the set of non-dedicated resources based on the received inter-UE coordination message, such as described in connection with FIG. 12. For example, at 1224, the second UE 1204 may configure at least one resource in the set of non-dedicated resources 1208 based on the inter-UE coordination message 1210. The configuration of the at least one resource in the set of non-dedicated resources may be performed by, e.g., the resource configuration component 1844 of the apparatus 1802 in FIG. 18.

At 1708, the second UE may transmit sidelink communication via the at least one resource in the set of non-dedicated resources, such as described in connection with FIG. 12. For example, at 1226, the second UE 1204 may transmit sidelink communication via at least one resource in the set of non-dedicated resources 1208. The transmission of the sidelink communication may be performed by, e.g., the sidelink communication configuration component 1846 and/or the transmission component 1834 of the apparatus 1802 in FIG. 18.

FIG. 18 is a diagram 1800 illustrating an example of a hardware implementation for an apparatus 1802. The apparatus 1802 may be a UE, a component of a UE, or may implement UE functionality. In some aspects, the apparatus 1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, or a power supply 1818. The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 includes an inter-UE coordination process component 1840 that is configured to receive, from a first UE, an inter-UE coordination message via one or more resources in a set of dedicated resources or in a set of non-dedicated resources, the inter-UE coordination message being associated with at least one of a first stage SCI format or a second stage SCI format, e.g., as described in connection with 1602 of FIGS. 16 and/or 1702 of FIG. 17. The communication manager 1832 further includes a resource indication process component 1842 that is configured to receive, from the first UE, an indication of the one or more resources in which the inter-UE coordination message is transmitted via the first stage SCI format or the second stage SCI format, e.g., as described in connection with 1604 of FIG. 16. The communication manager 1832 further includes a resource configuration component 1844 that is configured to configure at least one resource in the set of non-dedicated resources based on the received inter-UE coordination message, e.g., as described in connection with 1606 of FIGS. 16 and/or 1706 of FIG. 17. The communication manager 1832 further includes a sidelink communication configuration component 1846 that is configured to transmit sidelink communication via the at least one resource in the set of non-dedicated resources, e.g., as described in connection with 1608 of FIGS. 16 and/or 1708 of FIG. 17.

The apparatus may include additional components that perform each of the blocks of the algorithm in the flowcharts of FIGS. 16 and 17. As such, each block in the flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, includes means for receiving, from a first UE, an inter-UE coordination message via one or more resources in a set of dedicated resources or in a set of non-dedicated resources, the inter-UE coordination message being associated with at least one of a first stage SCI format or a second stage SCI format (e.g., the inter-UE coordination process component 1840 and/or the reception component 1830). The apparatus 1802 includes means for receiving, from the first UE, an indication of the one or more resources in which the inter-UE coordination message is transmitted via the first stage SCI format or the second stage SCI format (e.g., the resource indication process component 1842 and/or the reception component 1830). The apparatus 1802 includes means for configuring at least one resource in the set of non-dedicated resources based on the received inter-UE coordination message (e.g., the resource configuration component 1844). The apparatus 1802 includes means for transmitting sidelink communication via the at least one resource in the set of non-dedicated resources (e.g., the sidelink communication configuration component 1846 and/or the transmission component 1834).

In one configuration, the set of dedicated resources may correspond to at least one sub-channel in at least one slot. In another configuration, the set of dedicated resources correspond to at least one sub-channel in every X slots, where X may be an integer greater than or equal to two.

In another configuration, the inter-UE coordination message may be associated with a transmission priority that is lower than a PSCCH, a PSSCH, or a PSFCH if the inter-UE coordination message is transmitted via the one or more resources in the set of non-dedicated resources.

In another configuration, the first stage SCI format or the second stage SCI format may not include a resource reservation information if the inter-UE coordination message is received via the one or more resources in the set of dedicated resources.

The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to configure one or more resources in a set of dedicated resources or in a set of non-dedicated resources for a transmission of an inter-UE coordination message, the inter-UE coordination message being associated with at least one of a first stage SCI format or a second stage SCI format; and transmit the inter-UE coordination message via the one or more resources in the set of dedicated resources or in the set of non-dedicated resources.

Aspect 2 is the apparatus of aspect 1, where the set of dedicated resources correspond to at least one sub-channel in at least one slot.

Aspect 3 is the apparatus of any of aspects 1 and 2, where the set of dedicated resources correspond to at least one sub-channel in every X slots, X being an integer greater than or equal to two.

Aspect 4 is the apparatus of any of aspects 1 to 3, where the inter-UE coordination message is transmitted via the one or more resources in the set of dedicated resources, and where the inter-UE coordination message is transmitted without the first UE performing a resource sensing for the set of dedicated resources.

Aspect 5 is the apparatus of any of aspects 1 to 4, where the at least one processor is further configured to: perform a first resource sensing for the set of dedicated resources to determine whether any resources in the set of dedicated resources are available for transmission, where the inter-UE coordination message is transmitted via the one or more resources in the set of dedicated resources based on the set of dedicated resources having resources available for transmission.

Aspect 6 is the apparatus of any of aspects 1 to 5, where the at least one processor is further configured to: skip the transmission of the inter-UE coordination message if the set of dedicated resources does not have resources available for transmission.

Aspect 7 is the apparatus of any of aspects 1 to 6, where the at least one processor is further configured to: perform a second resource sensing for the set of non-dedicated resources to determine whether any resources in the set of non-dedicated resources are available for transmission if the set of dedicated resources does not have resources available for transmission, where the inter-UE coordination message is transmitted via the one or more resources in the set of non-dedicated resources based on the set of non-dedicated resources having resources available for transmission.

Aspect 8 is the apparatus of any of aspects 1 to 7, where the at least one processor is further configured to: perform a second resource sensing for the set of non-dedicated resources to determine whether any resources in the set of non-dedicated resources are available for transmission if the set of dedicated resources does not have resources available for transmission, where the inter-UE coordination message is transmitted via the one or more resources in the set of non-dedicated resources based on the set of non-dedicated resources having resources available for transmission.

Aspect 9 is the apparatus of any of aspects 1 to 8, where the inter-UE coordination message is associated with a transmission priority that is lower than a PSCCH, a PSSCH, or a PSFCH if the inter-UE coordination message is transmitted via the one or more resources in the set of non-dedicated resources.

Aspect 10 is the apparatus of any of aspects 1 to 9, where the where the at least one processor is further configured to: receive, from a base station, a configuration for the percentage threshold.

Aspect 11 is the apparatus of any of aspects 1 to 10, where the at least one processor is further configured to: modify the RSRP threshold if the available resource ratio for the set of dedicated resources or the set of non-dedicated resources does not meet the percentage threshold.

Aspect 12 is the apparatus of any of aspects 1 to 11, where the at least one processor is further configured to: receive, from a base station, a configuration for a maximum number of times in which the RSRP threshold can be modified.

Aspect 13 is the apparatus of any of aspects 1 to 12, where the at least one processor is further configured to: indicate, to a second UE, the one or more resources in which the inter-UE coordination message is transmitted via the first stage SCI format or the second stage SCI format.

Aspect 14 is the apparatus of any of aspects 1 to 13, where the one or more resources are periodic resources or aperiodic resources.

Aspect 15 is the apparatus of any of aspects 1 to 14, where the at least one processor is further configured to: skip transmitting the inter-UE coordination message in a retransmission.

Aspect 16 is the apparatus of any of aspects 1 to 15, where the first stage SCI format or the second stage SCI format does not include a resource reservation information if the inter-UE coordination message is transmitted via the one or more resources in the set of dedicated resources.

Aspect 17 is the apparatus of any of aspects 1 to 16, where at least one of the first stage SCI format or the second stage SCI format is adjusted after the inter-UE coordination message is transmitted.

Aspect 18 is the apparatus of any of aspects 1 to 17, where the at least one processor is further configured to: receive, from a second UE, sidelink communication via the set of non-dedicated resources.

Aspect 19 is the apparatus of any of aspects 1 to 18, where the inter-UE coordination message is a broadcast message.

Aspect 20 is the apparatus of any of aspects 1 to 19, where the one or more resources correspond to one or more resources that are suitable for sidelink communication from a second UE, or one or more resources that are not suitable for sidelink communication from the second UE.

Aspect 21 is the apparatus of any of aspects 1 to 20, further including a transceiver coupled to the at least one processor.

Aspect 22 is a method of wireless communication for implementing any of aspects 1 to 21.

Aspect 23 is an apparatus for wireless communication including means for implementing any of aspects 1 to 21.

Aspect 24 is a computer-readable medium storing computer executable code, where the code when executed by a processor causes the processor to implement any of aspects 1 to 21.

Aspect 25 is an apparatus for wireless communication including at least one processor coupled to a memory and configured to receive, from a first UE, an inter-UE coordination message via one or more resources in a set of dedicated resources or in a set of non-dedicated resources, the inter-UE coordination message being associated with at least one of a first stage SCI format or a second stage SCI format; configure at least one resource in the set of non-dedicated resources based on the received inter-UE coordination message; and transmit sidelink communication via the at least one resource in the set of non-dedicated resources.

Aspect 26 is the apparatus of aspect 25, where the set of dedicated resources correspond to at least one sub-channel in at least one slot.

Aspect 27 is the apparatus of any of aspects 25 and 26, where the set of dedicated resources correspond to at least one sub-channel in every X slots, X being an integer greater than or equal to two.

Aspect 28 is the apparatus of any of aspects 25 to 27, where the inter-UE coordination message is associated with a transmission priority that is lower than a PSCCH, a PSSCH, or a PSFCH if the inter-UE coordination message is transmitted via the one or more resources in the set of non-dedicated resources.

Aspect 29 is the apparatus of any of aspects 25 to 28, where the at least one processor is further configured to: receive, from the first UE, an indication of the one or more resources in which the inter-UE coordination message is transmitted via the first stage SCI format or the second stage SCI format.

Aspect 30 is the apparatus of any of aspects 25 to 29, where the one or more resources are periodic resources or aperiodic resources.

Aspect 31 is the apparatus of any of aspects 25 to 30, where the first stage SCI format or the second stage SCI format does not include a resource reservation information if the inter-UE coordination message is received via the one or more resources in the set of dedicated resources.

Aspect 32 is the apparatus of any of aspects 25 to 31, where the inter-UE coordination message is a broadcast message.

Aspect 33 is the apparatus of any of aspects 25 to 32, further including a transceiver coupled to the at least one processor.

Aspect 34 is a method of wireless communication for implementing any of aspects 25 to 33.

Aspect 35 is an apparatus for wireless communication including means for implementing any of aspects 25 to 33.

Aspect 36 is a computer-readable medium storing computer executable code, where the code when executed by a processor causes the processor to implement any of aspects 25 to 33.

What is claimed is:

1. An apparatus for wireless communication at a first user equipment (UE), comprising:
a memory; and
at least one processor coupled to the memory and configured to:
configure one or more resources in a set of dedicated resources or in a set of non-dedicated resources for a transmission of an inter-UE coordination message, the inter-UE coordination message being associated with at least one of a first stage sidelink control information (SCI) format or a second stage SCI format; and
transmit the inter-UE coordination message via the one or more resources in the set of dedicated resources or in the set of non-dedicated resources.

2. The apparatus of claim 1, wherein the set of dedicated resources corresponds to at least one sub-channel in at least one slot.

3. The apparatus of claim 1, wherein the set of dedicated resources corresponds to at least one sub-channel in every X slots, X being an integer greater than or equal to two.

4. The apparatus of claim 1, wherein the inter-UE coordination message is transmitted via the one or more resources in the set of dedicated resources, and wherein the inter-UE coordination message is transmitted without the first UE performing a resource sensing for the set of dedicated resources.

5. The apparatus of claim 1, wherein the at least one processor is further configured to:
perform a first resource sensing for the set of dedicated resources to determine whether any resources in the set of dedicated resources are available for a transmission, wherein the inter-UE coordination message is transmitted via the one or more resources in the set of dedicated resources based on the set of dedicated resources having resources available for the transmission.

6. The apparatus of claim 5, wherein the at least one processor is further configured to:
skip the transmission of the inter-UE coordination message if the set of dedicated resources does not have resources available for the transmission.

7. The apparatus of claim 5, wherein the at least one processor is further configured to:
perform a second resource sensing for the set of non-dedicated resources to determine whether any resources in the set of non-dedicated resources are available for a transmission if the set of dedicated resources does not have resources available for the transmission, wherein the inter-UE coordination message is transmitted via the one or more resources in the set of non-dedicated resources based on the set of non-dedicated resources having resources available for the transmission.

8. The apparatus of claim 1, wherein the inter-UE coordination message is associated with a transmission priority that is lower than a physical sidelink control channel (PSCCH), a physical sidelink shared channel (PSSCH), or a physical sidelink feedback channel (PSFCH) if the inter-UE coordination message is transmitted via the one or more resources in the set of non-dedicated resources.

9. The apparatus of claim 1, wherein the at least one processor is further configured to:
perform a resource sensing for the set of dedicated resources or the set of non-dedicated resources based on a reference signal received power (RSRP) threshold to determine an available resource ratio for the set of dedicated resources or the set of non-dedicated resources, and wherein the inter-UE coordination message is transmitted via the one or more resources in the set of dedicated resources or the set of non-dedicated resources based on the available resource ratio meeting a percentage threshold.

10. The apparatus of claim 9, wherein the at least one processor is further configured to:
receive, from a base station, a configuration for the percentage threshold.

11. The apparatus of claim 9, wherein the at least one processor is further configured to:
modify the RSRP threshold if the available resource ratio for the set of dedicated resources or the set of non-dedicated resources does not meet the percentage threshold.

12. The apparatus of claim 11, wherein the at least one processor is further configured to:
receive, from a base station, a configuration for a maximum number of times in which the RSRP threshold can be modified.

13. The apparatus of claim 1, wherein the at least one processor is further configured to:
indicate, to a second UE, the one or more resources in which the inter-UE coordination message is transmitted via the first stage SCI format or the second stage SCI format.

14. The apparatus of claim 13, wherein the one or more resources are periodic resources or aperiodic resources.

15. The apparatus of claim 1, wherein the at least one processor is further configured to:
skip transmitting the inter-UE coordination message in a retransmission.

16. The apparatus of claim 1, wherein the first stage SCI format or the second stage SCI format does not include a resource reservation information if the inter-UE coordination message is transmitted via the one or more resources in the set of dedicated resources.

17. The apparatus of claim 1, wherein at least one of the first stage SCI format or the second stage SCI format is adjusted after the inter-UE coordination message is transmitted.

18. The apparatus of claim 1, wherein the at least one processor is further configured to:
receive, from a second UE, sidelink communication via the set of non-dedicated resources.

19. The apparatus of claim 1, wherein the inter-UE coordination message is a broadcast message.

20. The apparatus of claim 1, wherein the one or more resources correspond to one or more resources that are suitable for sidelink communication from a second UE, or correspond to one or more resources that are not suitable for sidelink communication from the second UE.

21. The apparatus of claim 1, further comprising a transceiver coupled to the at least one processor.

22. A method of wireless communication at a first user equipment (UE), comprising:
configuring one or more resources in a set of dedicated resources or in a set of non-dedicated resources for a transmission of an inter-UE coordination message, the inter-UE coordination message being associated with at least one of a first stage sidelink control information (SCI) format or a second stage SCI format; and
transmitting the inter-UE coordination message via the one or more resources in the set of dedicated resources or in the set of non-dedicated resources.

23. An apparatus for wireless communication at a second user equipment (UE), comprising:
a memory; and
at least one processor coupled to the memory and configured to:
receive, from a first UE, an inter-UE coordination message via one or more resources in a set of dedicated resources or in a set of non-dedicated resources, the inter-UE coordination message being associated with at least one of a first stage sidelink control information (SCI) format or a second stage SCI format;
configure at least one resource in the set of non-dedicated resources based on the received inter-UE coordination message; and
transmit sidelink communication via the at least one resource in the set of non-dedicated resources.

24. The apparatus of claim 23, wherein the set of dedicated resources corresponds to at least one sub-channel in at least one slot.

25. The apparatus of claim 23, wherein the set of dedicated resources corresponds to at least one sub-channel in every X slots, X being an integer greater than or equal to two.

26. The apparatus of claim 23, wherein the inter-UE coordination message is associated with a transmission priority that is lower than a physical sidelink control channel (PSCCH), a physical sidelink shared channel (PSSCH), or a physical sidelink feedback channel (PSFCH) if the inter-UE coordination message is received via the one or more resources in the set of non-dedicated resources.

27. The apparatus of claim 23, wherein the at least one processor is further configured to:
receive, from the first UE, an indication of the one or more resources in which the inter-UE coordination message is transmitted via the first stage SCI format or the second stage SCI format, and wherein the one or more resources are periodic resources or aperiodic resources.

28. The apparatus of claim 23, wherein the first stage SCI format or the second stage SCI format does not include a resource reservation information if the inter-UE coordination message is received via the one or more resources in the set of dedicated resources.

29. The apparatus of claim 23, further comprising a transceiver coupled to the at least one processor.

30. A method of wireless communication at a second user equipment (UE), comprising:
receiving, from a first UE, an inter-UE coordination message via one or more resources in a set of dedicated resources or in a set of non-dedicated resources, the inter-UE coordination message being associated with at least one of a first stage sidelink control information (SCI) format or a second stage SCI format;
configuring at least one resource in the set of non-dedicated resources based on the received inter-UE coordination message; and
transmitting sidelink communication via the at least one resource in the set of non-dedicated resources.
